(19) United States
(12) Patent Application Publication
(10) Pub. No.: US 2025/0272954 A1
(43) Pub. Date: Aug. 28, 2025

(54) SYSTEM AND METHOD FOR MULTIPLEX IMAGING CELL TYPING AND PHENOTYPIC MARKER QUANTIFICATION

(71) Applicant: NUCLEAI LTD., Tel Aviv (IL)

(72) Inventor: Ettai MARKOVITS, Ramat Gan (IL)

(21) Appl. No.: 19/204,822

(22) Filed: May 12, 2025

Related U.S. Application Data
(63) Continuation of application No. PCT/IL2023/051161, filed on Nov. 9, 2023.
(60) Provisional application No. 63/424,175, filed on Nov. 10, 2022.

(51) Int. Cl. G06V 10/762; G06T 7/11; G06V 10/50; G16B 40/20

(52) U.S. Cl. CPC G06V 10/762; G06T 7/11; G06V 10/507; G16B 40/20; G06T 2207/20081; G06T 2207/20132

(57) ABSTRACT

A system and method of classifying cells may include receiving a multichannel image depicting biological cells in a pathology slide, wherein said multichannel image comprises a plurality of channels, corresponding to a respective plurality of protein marker types; extracting, from the multichannel image, one or more multichannel tiles, each depicting a predetermined area that surrounds a center point of a specific, respective cell; splitting at least one of the one or more multichannel tiles into a plurality of single-channel tiles, corresponding to said plurality of protein marker types; inferring a pretrained, single-channel Machine Learning (ML) based classifier on one or more of the single-channel tiles, to predict one or more respective protein marker expression probability values; and identifying a type of the specific cell based on the one or more protein marker expression probability values.

### CROSS-REFERENCE TO RELATED APPLICATIONS

This application is a Bypass Continuation of PCT Patent Application No. PCT/IL2023/051161 having International filing date of Nov. 9, 2023, which claims the benefit of priority of U.S. Patent Application No. 63/424,175, filed Nov. 10, 2022 and entitled: “SYSTEM AND METHOD FOR MULTIPLEX IMAGING CELL TYPING AND PHENOTYPIC MARKER QUANTIFICATION”, the contents of which are all incorporated herein by reference in their entirety.

### FIELD OF THE INVENTION

The present invention relates generally to multiplex imaging cell typing and phenotypic marker quantification. More specifically, the present invention relates to using machine learning for multiplex imaging cell typing and phenotypic marker quantification.

### BACKGROUND OF THE INVENTION

Cellular organization within tissues is a crucial aspect for understanding the biological functions and processes in health, disease and malignancy. Spatial biology provides invaluable insights into the complex interactions and relationships between the distinct cells that drive tissue functions in health, and underlie the orchestration of immune response against pathogens and tumors. Accordingly, recognition has grown for the importance of the tumor microenvironment (TME) and immune composition within the tumor area in determining the clinical outcomes of immunotherapy-treated cancer patients. As a result, several tools have been developed to extract high-dimensional cellular properties while preserving tissue-wide spatial context, at the forefront of which are multiplexed tissue imaging technologies such as multiplex immunofluorescence (mIF).

In an mIF experiment, iterative staining, imaging, and washing cycles are applied to acquire up to 100 unique markers, which are then mapped to distinct cells within a single histological section, providing a highly-detailed roadmap of the TME. However, the analysis of mIF is hindered by the challenge in combining data from marker intensities to meaningful biological features, such as cell types and cell states of identified cells. As current existing methods such as clustering and manual thresholding, are laborious, user-dependent and underperforming, especially in rare cell types, there is a need for a more robust and automated pipeline for multiplex imaging analysis.

Unsupervised machine learning algorithms for automated cell typing of multiplex images have reported F1-scores between 0.6 and 0.7 across major cell types and between 0.4 and 0.6 for rare cell types using a co-detection by indexing (CODEX) colorectal cancer (CRC) dataset. However, the ground truth used for calculating these metrics was clustering-based cell typing which validity is not yet established.

### SUMMARY OF THE INVENTION

The terms “Multiplex Immunofluorescence (mIF) image” and “multichannel image” may be used herein interchangeably, to indicate a data structure that may include a plurality of layers or channels, depicting biological cells in a pathology slide. The plurality of channels in a multichannel image may represent, or correspond to a respective plurality of protein marker types.

As known in the art, mIF image analysis can provide invaluable insights into spatial biology and the complexities of the immune tumor microenvironment (iTME). However, existing analysis approaches are both laborious and highly user-dependent. In order to overcome these limitations, a novel, end-to-end deep learning (DL) pipeline for rapid and accurate analysis of both tumor-microarray (TMA) and whole slide mIF images is presented.

The pipeline, according to some embodiments of the present invention, may consist of two DL models: a multi-classifier for classifying multi-channel cell images into a plurality (e.g., 12) of different cell types, and a binary classifier for determining the positivity of a given marker in single-channel images. The DL multi-classifier may be trained on tiles labeled with cell annotations (e.g., from a publicly available CODEX dataset, consisting of 140 tissue cores from 35 colorectal cancer (CRC) patients). For the binary classifier training, the multi-channel tiles may be further split into single-channel tiles, for which the ground truth may be inferred from the known expression of these markers in each cell-type. Therefore, the terms “binary classifier” and “single-channel classifier” may be used herein interchangeably. This DL binary classifier may then be utilized to quantify the positivity of various cell state (phenotypic) markers. In addition, the binary classifier may be exploited as a cell-typing tool, by predicting the positivity of individual lineage cell markers.

The performance of the DL models according to embodiments of the present invention, was evaluated on 1,800 annotations from 14 test tissue cores. The models were further evaluated on a new 6-plex melanoma cohort, stained with PhenoImager®, and were compared to the performance of clustering, manual thresholding or machine learning-based cell-typing methods applied on the same test sets.

The DL multi-classifier, according to embodiments of the present invention, achieved highly accurate results, outperforming all of the tested cell-typing methods, including clustering, manual-thresholding and ML-based approaches, in both CODEX CRC and PhenoImager melanoma cohorts (accuracy of 91% and 87%, respectively), with F1-scores above 80% in the vast majority of cell types. The DL binary classifier, which was trained solely on the lineage markers of the CRC dataset, also outperformed existing methods, demonstrating excellent F1-scores (>80%) for determining the positivity of unseen phenotypic and lineage markers across the two tumor types and imaging modalities. Notably, as little as 20 annotations were required in order to boost the performance on an unseen dataset to above 85% accuracy and 80% F1-scores. As a result, the DL binary classifier may be used as a cell-typing model, in a manner that is transferable between experimental approaches.

Embodiments of the present invention may provide a DL-based framework for multiplex imaging analysis, which enables accurate cell typing and phenotypic marker quantification, which is robust across markers, tumor indications, and imaging modalities.

Embodiments of the invention may include a method of classifying cells by at least one processor.

According to some embodiments, the at least one processor may, for example, receiving a multichannel image depicting biological cells in a pathology slide. The multichannel image may include a plurality of channels, corresponding to a respective plurality of protein marker types. The at least one processor may extract, from the multichannel image, one or more multichannel tiles, each depicting a predetermined area that surrounds a center point of a specific, respective cell. The at least one processor may subsequently split at least one of the one or more multichannel tiles into a plurality of single-channel tiles, corresponding to said plurality of protein marker types; infer a pretrained, single-channel Machine Learning (ML) based classifier on one or more of the single-channel tiles, to predict one or more respective protein marker expression probability values; and identify a type of the specific cell based on the one or more protein marker expression probability values.

The at least one processor may identify a type of the specific cell by: for at least one single-channel tile, (i) calculating a dynamic decision threshold value, and (ii) applying the dynamic decision threshold value on the protein marker expression probability value, to determine a binary protein marker expression value; and applying rule-based logic on binary protein marker expression values of one or more single-channel tiles, to determine the type of the specific cell.

The at least one processor may repeat the inferring of the single-channel ML based classifier with single-channel tiles originating from a plurality of multichannel tiles, to obtain respective protein marker expression probability values. Additionally, or alternatively, the at least one processor may repeat the identifying of a type with cells depicted in the plurality of multichannel tiles, to determine respective cell types of the depicted cells. The at least one processor may then cluster the plurality of multichannel tiles according to their determined cell types, to form a clustering model in a multidimensional marker expression probability space, wherein each cluster of the clustering model corresponds to a specific cell type.

According to some embodiments, the at least one processor may obtain a tuple of protein marker expression probability values, representing a corresponding biological cell of interest; based on said tuple, the at least one processor may calculate one or more distance metric values, representing distances between the biological cell of interest and one or more clusters in the multidimensional marker expression probability space; and associate the biological cell of interest to a cluster of the clustering model, based on the calculated distance metric values.

According to some embodiments, the at least one processor may obtain a training dataset that may include (i) a plurality of training single-channel tiles, and (ii) associated single-channel tile annotations. The at least one processor may then use the single-channel tile annotations, to train the single-channel ML classifier, so as to predict protein marker expression probability values of respective training single-channel tiles.

According to some embodiments, the single-channel tile annotations may (a) include indication of existence of a protein marker in the associated single-channel tiles, and (b) be devoid of indication of specific protein marker types in the associated single-channel tiles.

According to some embodiments, the at least one processor may obtain the training dataset by receiving a specific multichannel tile of a multichannel image, and a respective cell type annotation indicating a type of a cell depicted in the specific multichannel tile; and applying rule-based logic on the cell type annotation, to obtain a plurality of single-channel tile annotations. Each single-channel tile annotation may (i) pertain to a specific channel of the specific multichannel tile, and (ii) represent protein marker expression in that channel.

Additionally, or alternatively, the at least one processor may extract a multichannel tile by applying a segmentation algorithm on the multichannel image to produce at least one segment representing a depicted biological cell; calculating a center of mass of said segment; and defining the multichannel tile as an area of pixels surrounding the calculated center of mass.

Additionally, or alternatively, the at least one processor may, for at least one channel of the multichannel image, calculate a brightness histogram representing distribution of pixel intensities in the channel; and normalizing intensity values of the channel's pixels based on said distribution.

According to some embodiments, the at least one processor may normalize intensity values of the channel's pixels by identifying a first pixel intensity value, which corresponding to a peak of the brightness histogram, which represents a background region of the channel; identifying a second pixel intensity value, which directly exceeds the intensity of a predetermined quantile of cells depicted in the multichannel image; and normalizing intensity values of pixels of the channel according to the range between the first pixel intensity value and the second pixel intensity value.

Additionally, or alternatively, the at least one processor may obtain an initial version of a multichannel ML based classification model, configured to classify an example of a multichannel tile according to a type of a biological cell depicted in the example of the multichannel tile; obtaining an instant multichannel tile, may include a plurality of single-channel tiles; and infer the single-channel ML based classifier on one or more of the single-channel tiles of the instant multichannel tile, to predict one or more respective protein marker expression probability values. Based on the one or more protein marker expression probability values, The at least one processor may produce a cell-type label, representing a type of the cell depicted in the instant multichannel tile; and use the cell type label as supervisory information, to retrain the multichannel ML based classification model, so as to predict a type of the biological cell depicted in the instant multichannel tile.

Embodiments of the invention may include a system for classifying cells. Embodiments of the system may include: a non-transitory memory device, wherein modules of instruction code may be stored, and at least one processor associated with the memory device, and configured to execute the modules of instruction code. Upon execution of the modules of instruction code, the at least one processor may be configured to receive a multichannel image depicting biological cells in a pathology slide. The multichannel image may include a plurality of channels, corresponding to a respective plurality of protein marker types. The at least one processor may subsequently extract, from the multichannel image, one or more multichannel tiles, each depicting a predetermined area that surrounds a center point of a specific, respective cell; split at least one of the one or more multichannel tiles into a plurality of single-channel tiles, corresponding to said plurality of protein marker types; infer a pretrained, single-channel ML based classifier on one or more of the single-channel tiles, to predict one or more respective protein marker expression probability values; and identify a type of the specific cell based on the one or more protein marker expression probability values.

Embodiments of the invention may include a method of creating a training dataset for a deep learning (DL) multichannel classifier by at least one processor. Embodiments of the method may include receiving at least one multiplex immunofluorescence (mIF) image; splitting the at least one mIF image into a plurality of single channel images; predicting, by a trained single-channel DL classifier, the expression of markers in each of the plurality of single channels; determining, based on the prediction in each of the plurality of single channel images, and known lineage markers expression data, a cell type in each of the at least one mIF image; and automatically annotating the at least one mIF image, wherein the annotated at least one mIF image may be added to a training dataset of the DL multichannel classifier.

Embodiments of the invention may include a method of training a deep learning (DL) pipeline for cell typing in multiplex imaging by at least one processor. Embodiments of the method may include receiving one or more mIF images containing a panel of cell lineage markers; segmenting the one or more mIF images to identify cell instances in each of the one or more mIF images; receiving a training set of segmented cells annotated with cell types; cropping the annotated training set images into tiles may include single cell centers; feeding the tiles into one of a DL-based multichannel classifier, and a DL-based binary classifier; and training the DL-based classifier to identify cell types.

Embodiments of the invention may include a system for creating a training dataset for a deep learning (DL) multichannel classifier. Embodiments of the system may include a non-transitory memory device, wherein modules of instruction code may be stored, and at least one processor associated with the memory device, and configured to execute the modules of instruction code. Upon execution of said modules of instruction code, the at least one processor may be configured to: receive at least one multiplex mIF image; split the at least one mIF image into a plurality of single channel images; predict, by a trained single-channel DL classifier, the expression of markers in each of the plurality of single channels; determine, based on the prediction in each of the plurality of single channel images, and known lineage markers expression data, a cell type in each of the at least one mIF image; and automatically annotate the at least one mIF image, wherein the annotated at least one mIF image may be added to a training dataset of the DL multichannel classifier.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for multiplex imaging cell typing and phenotypic marker quantification according to some embodiments of the invention;

FIG. P2A is a block diagram, depicting a deep-learning (DL) pipeline for cell-typing in multiplex imaging according to some embodiments;

FIG. P2B depicts lineage and immunomodulatory (phenotypic) markers stained in the publicly available dataset that was utilized in a study further described below;

FIG. P2C is a confusion matrix for the DL multichannel classifier predicted cell types, according to some embodiments;

FIG. P2D shows a comparison of the balanced accuracy and F1 scores between DL multichannel classifier according to embodiments of the present invention, and a clustering-based cell-typing approach;

FIG. P2E shows a breakdown of the number of cell type annotations on the CRC CODEX dataset for each of the 12 classes;

FIG. P2F shows a confusion matrix for the ML-based multichannel classifier (XGBoost);

FIG. P2G presents a comparison of the balanced accuracy and F1 scores between DL multichannel classifier according to embodiments of the present invention, and an ML-based cell-typing approach;

FIG. P3A is an illustration of a single-channel binary classifier, according to some embodiments, for predicting the positivity of cell state markers;

FIGS. P3B, P3C, P3D, P3E, P3F and P3G provide the results of evaluation of the performance of the single-channel binary classifier of FIG. P3A;

FIGS. P4A, P4B, P4C and P4D illustrate Utilization of the DL binary classifier as a cell-typing model according to some embodiments; and

FIGS. P5A, P5B, P5C, PSD, P5E, P5F, P5G, P5H, P5I, P5J and 5K illustrate the application of the DL binary classifier, according to some embodiments, for cell-typing on a new tumor type and imaging modality;

FIG. 2 is a block diagram, depicting a system for multiplex imaging cell typing and phenotypic marker quantification according to some embodiments of the invention;

FIG. 3A depicts an example of a multichannel or mIF image, where each channel may represent (e.g., by a unique color) an expression of a respective protein marker type, as known in the art.

FIG. 3B depicts an example of classification of cells depicted in the multichannel or mIF image of FIG. 3A, according to respective cell types, as obtained by embodiments of the invention;

FIG. 3C depicts an example of segmentation of a multichannel image, according to some embodiments of the invention;

FIG. 3D depicts an example of a multichannel tile, which may be comprised of a plurality of single-channel tiles, according to some embodiments of the invention;

FIG. 4A is a schematic graph showing an example of a brightness histogram of pixel intensity values in a specific channel of a multichannel image, according to some embodiments of the invention;

FIG. 4B is a schematic graph showing an example of distribution of protein marker expression probability values in a cohort of cells, according to some embodiments of the invention;

FIG. 4C is a schematic example of a table, implementing cell-level, rule based logic, showing an example of distribution of protein marker expression probability values in a cohort of cells, according to some embodiments of the invention;

FIG. 5A is a flow diagram showing an example of a method of classifying cell types in a multichannel image by at least one processor, according to some embodiments of the invention;

FIG. 5B is a flow diagram showing an example of a method of creating a training dataset for a DL multichannel classifier by at least one processor, according to some embodiments of the invention; and

FIG. 5C is a flow diagram showing an example of a method of training a deep learning (DL) pipeline for cell typing in multiplex imaging by at least one processor, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

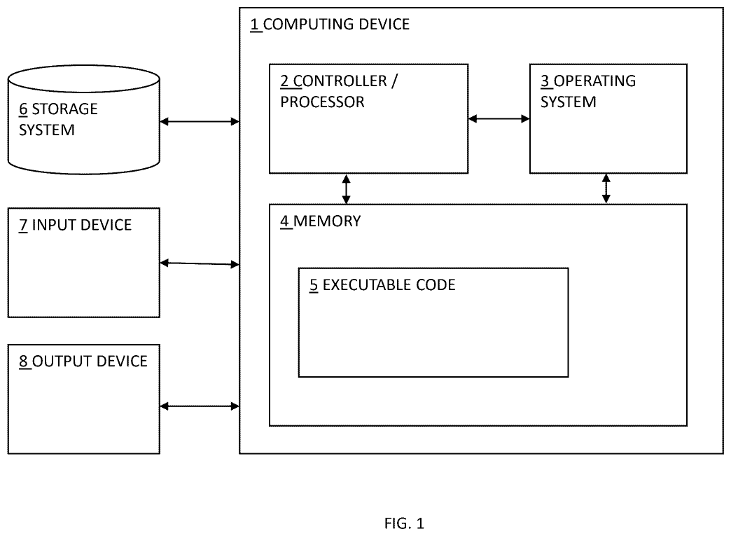

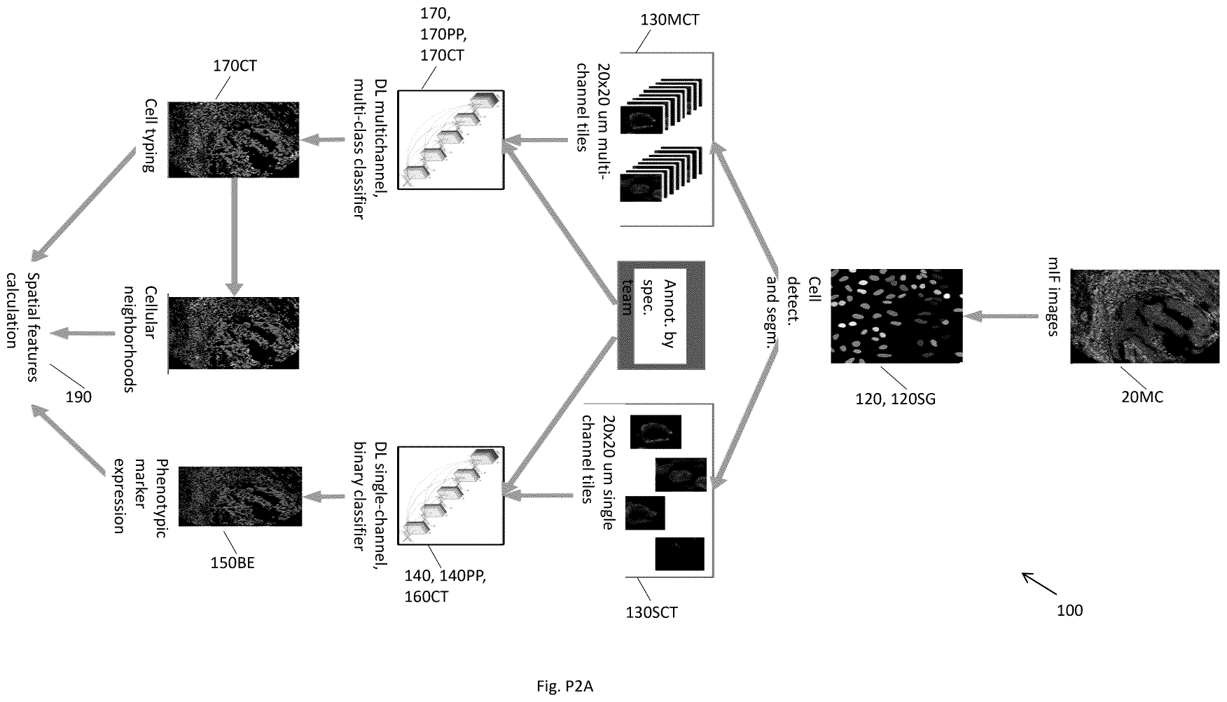

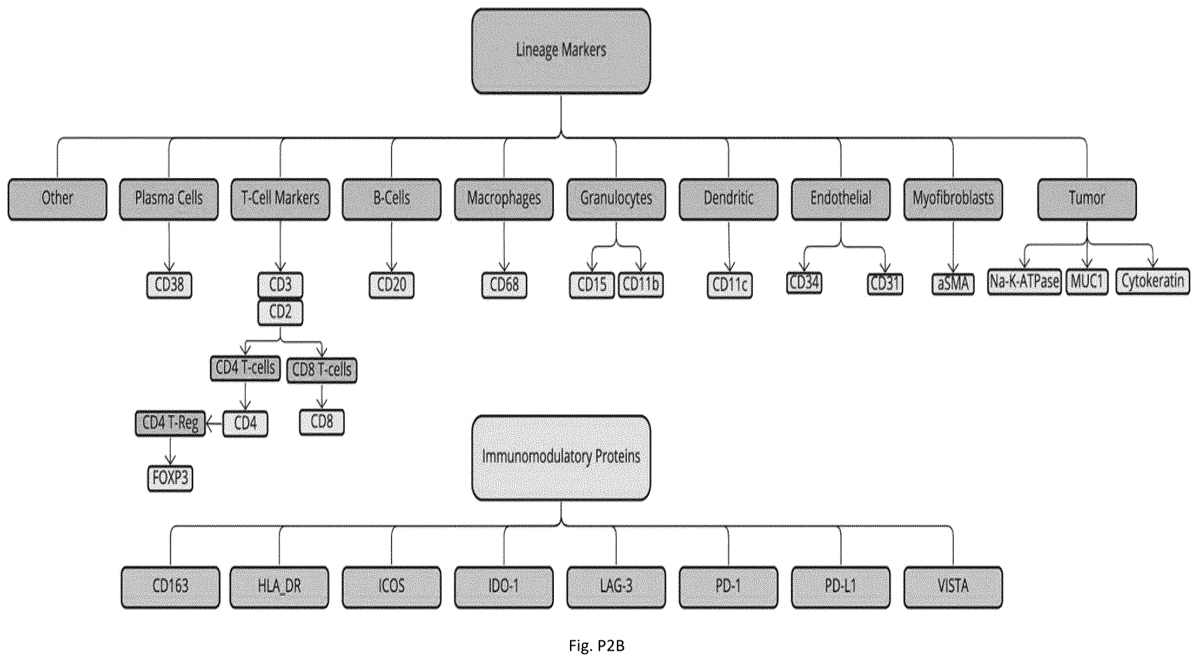

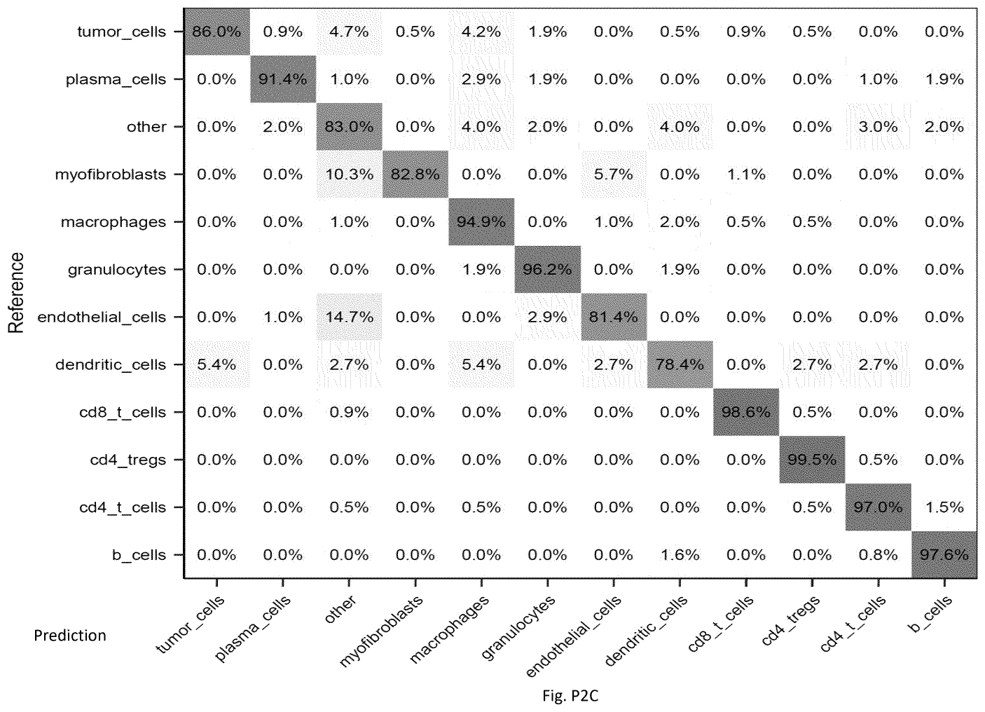

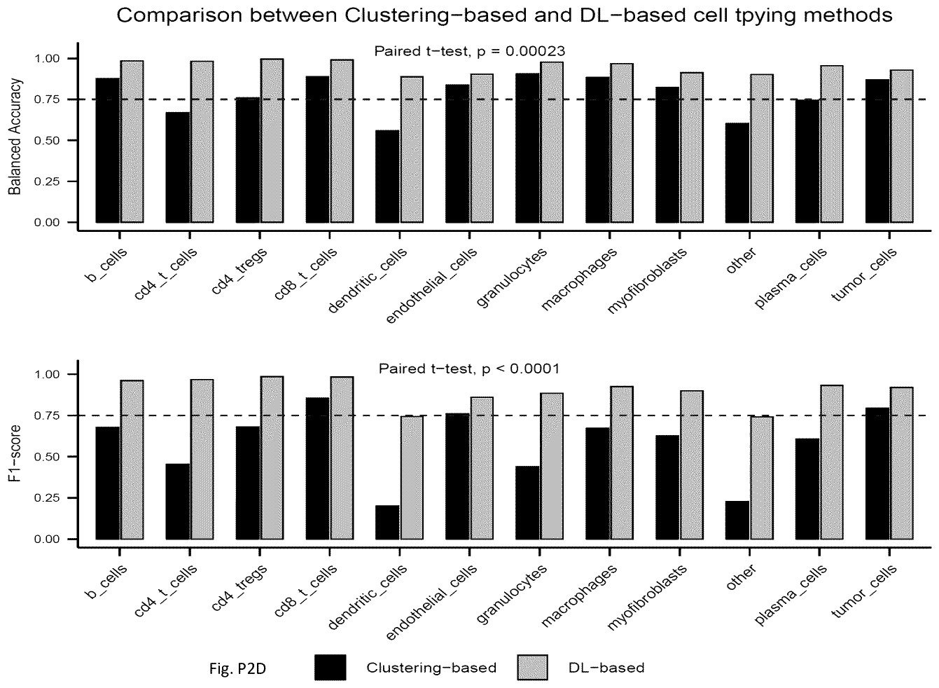

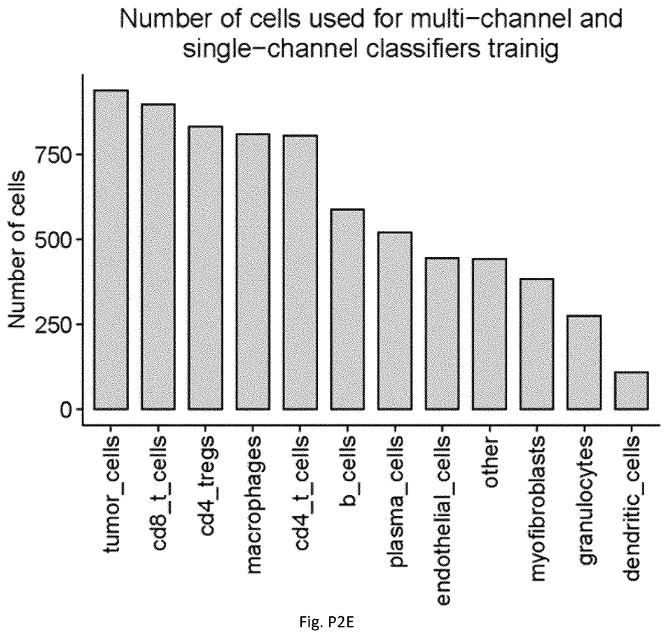

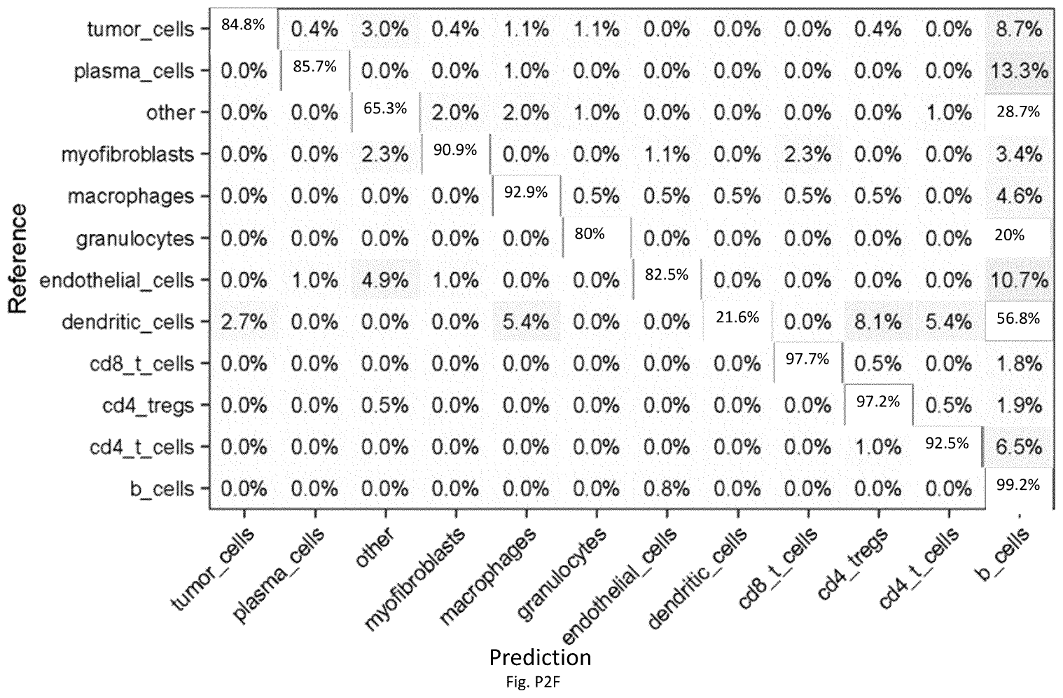

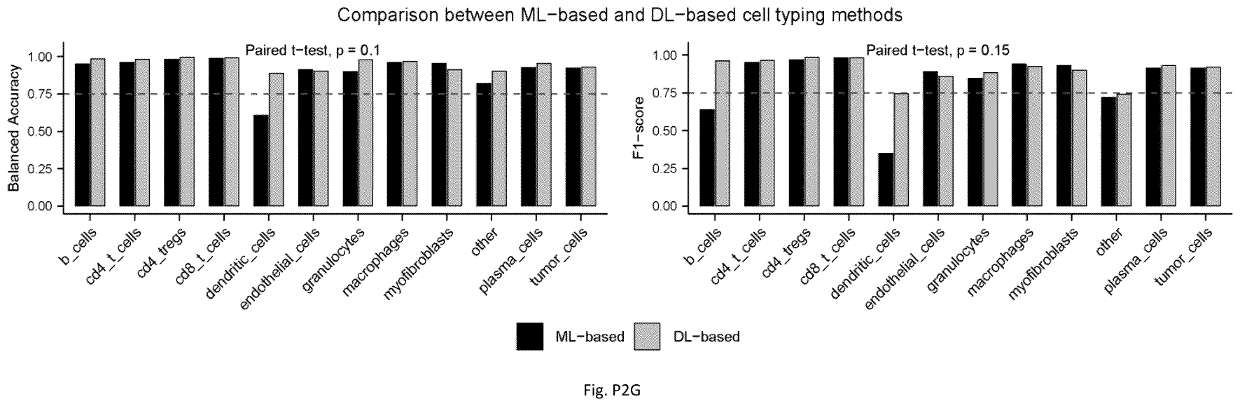

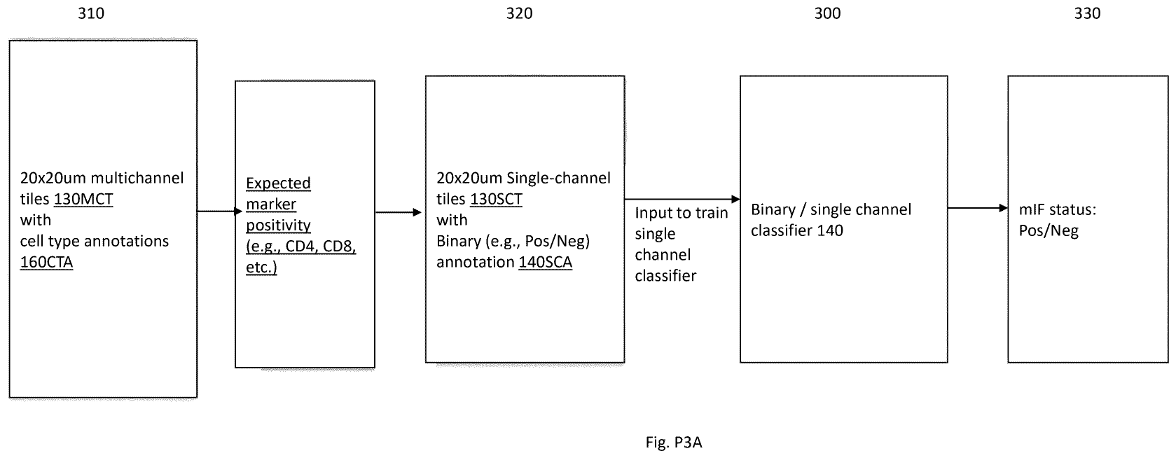

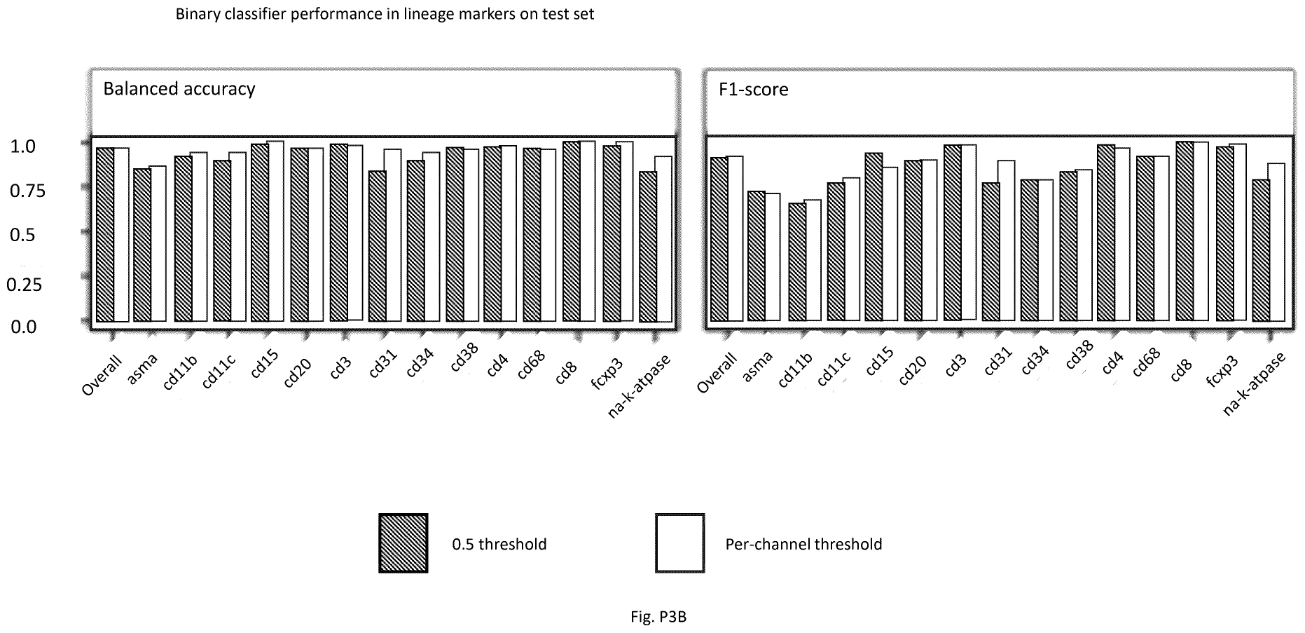

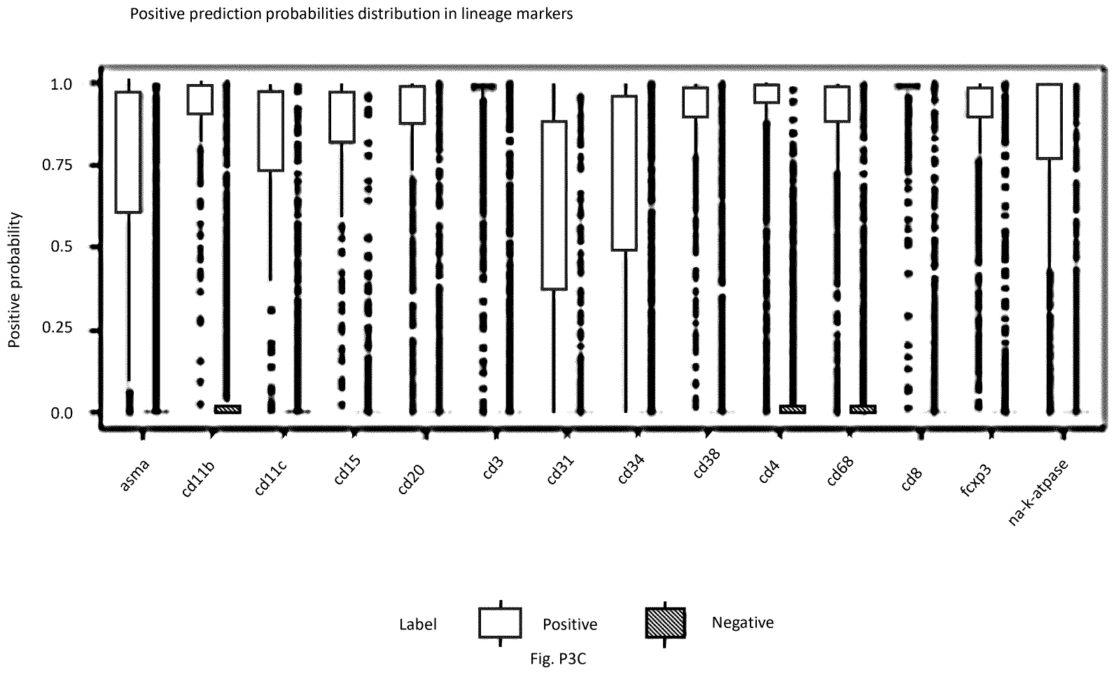

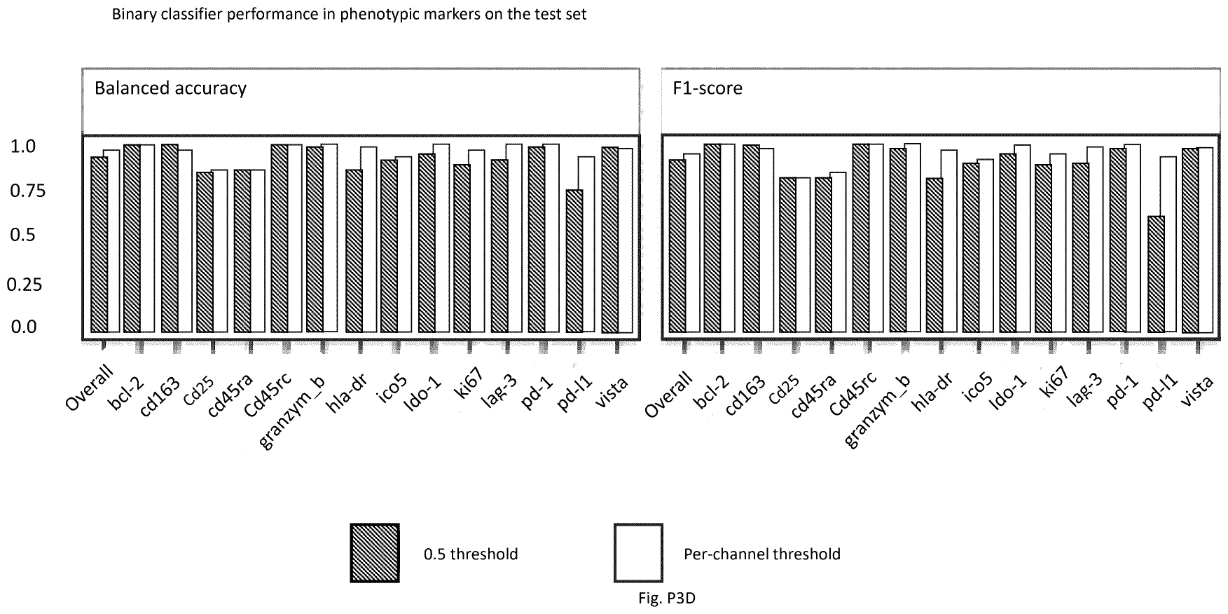

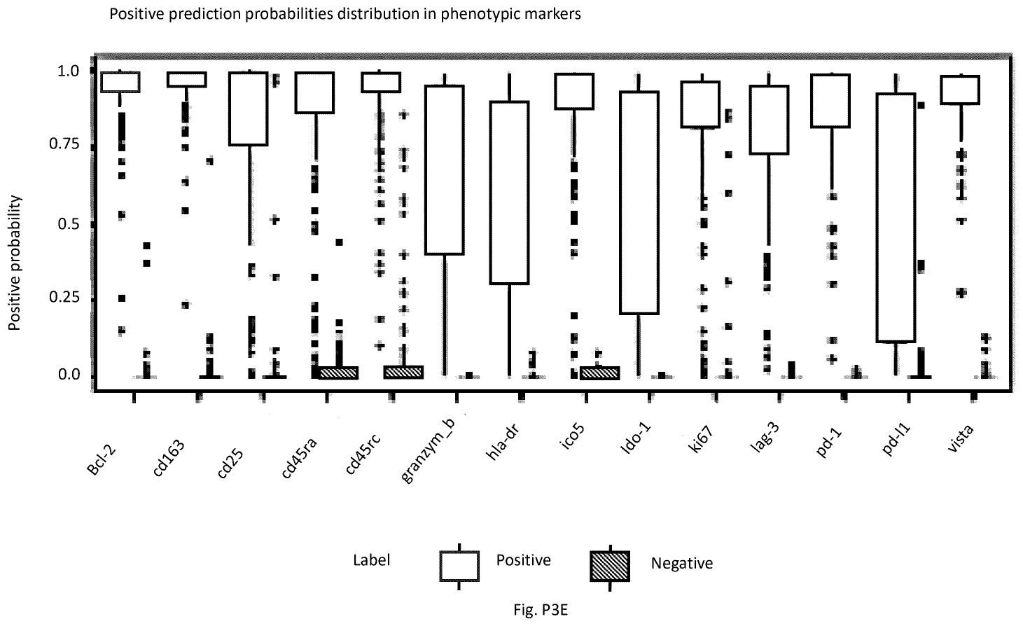

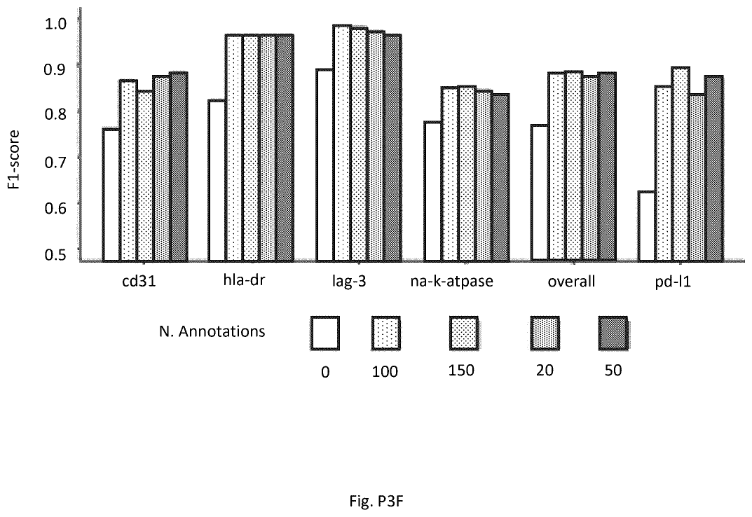

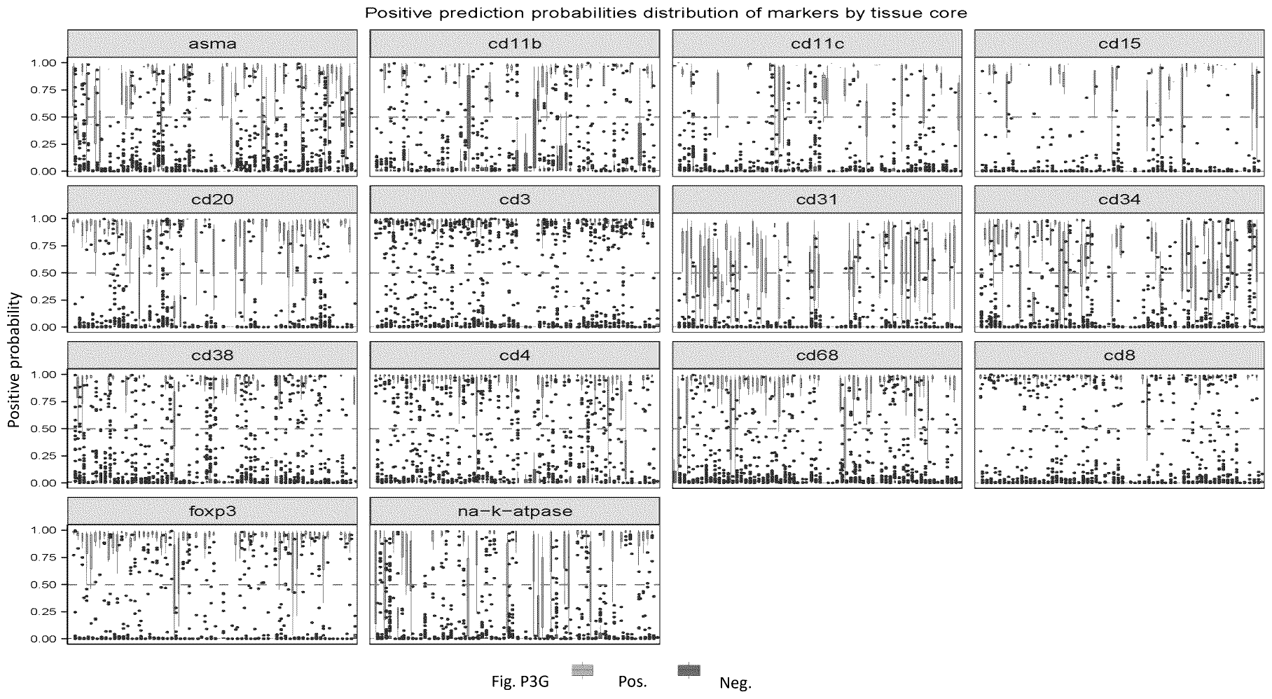

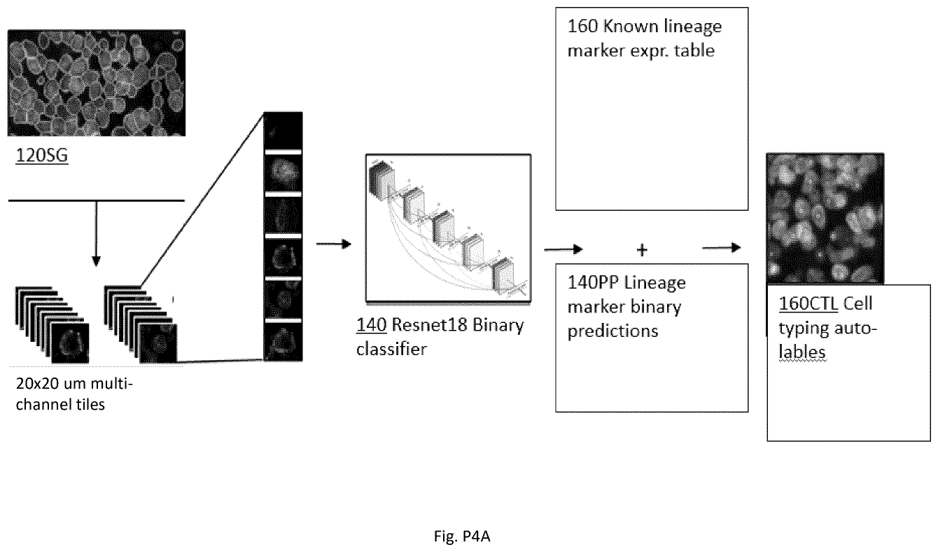

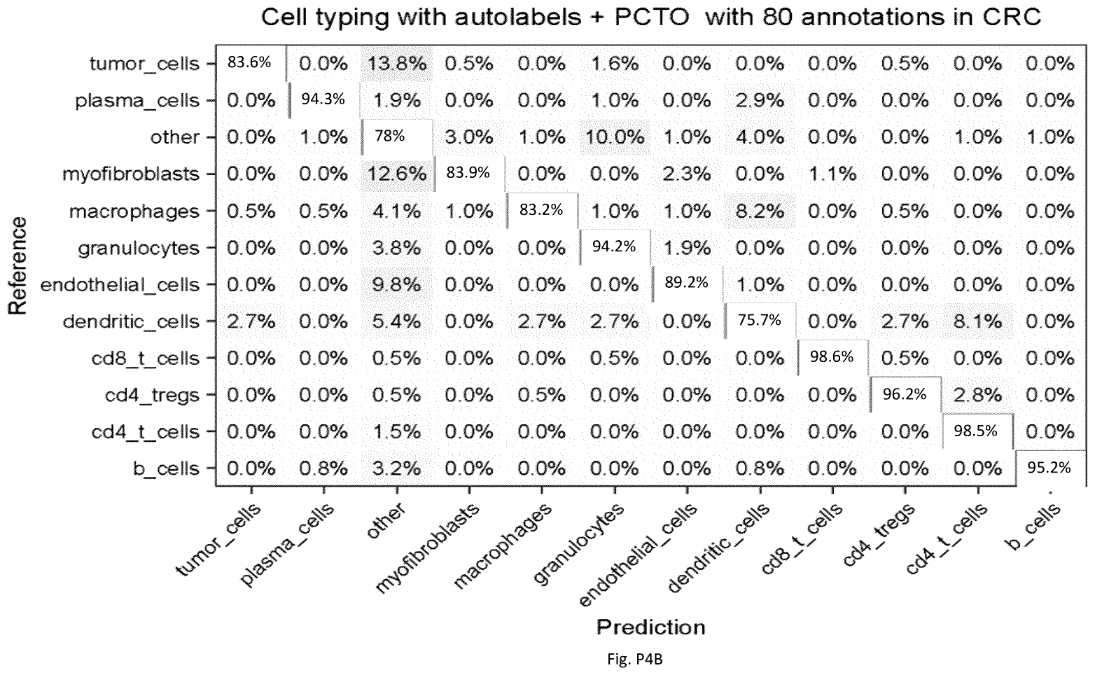

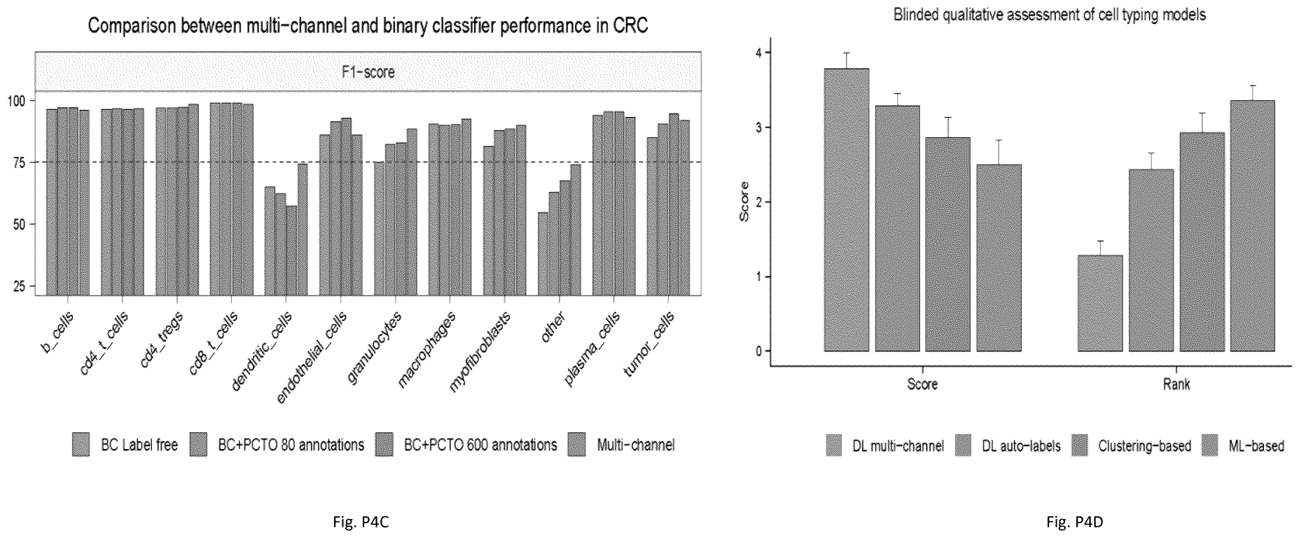

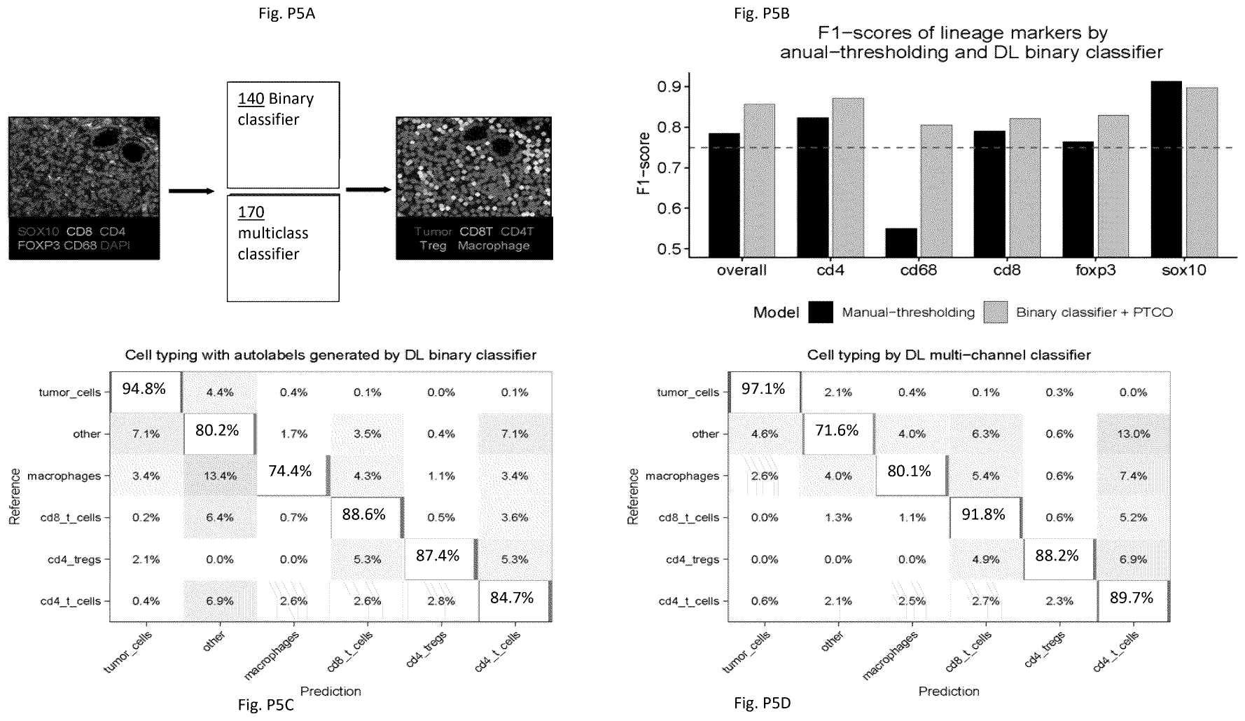

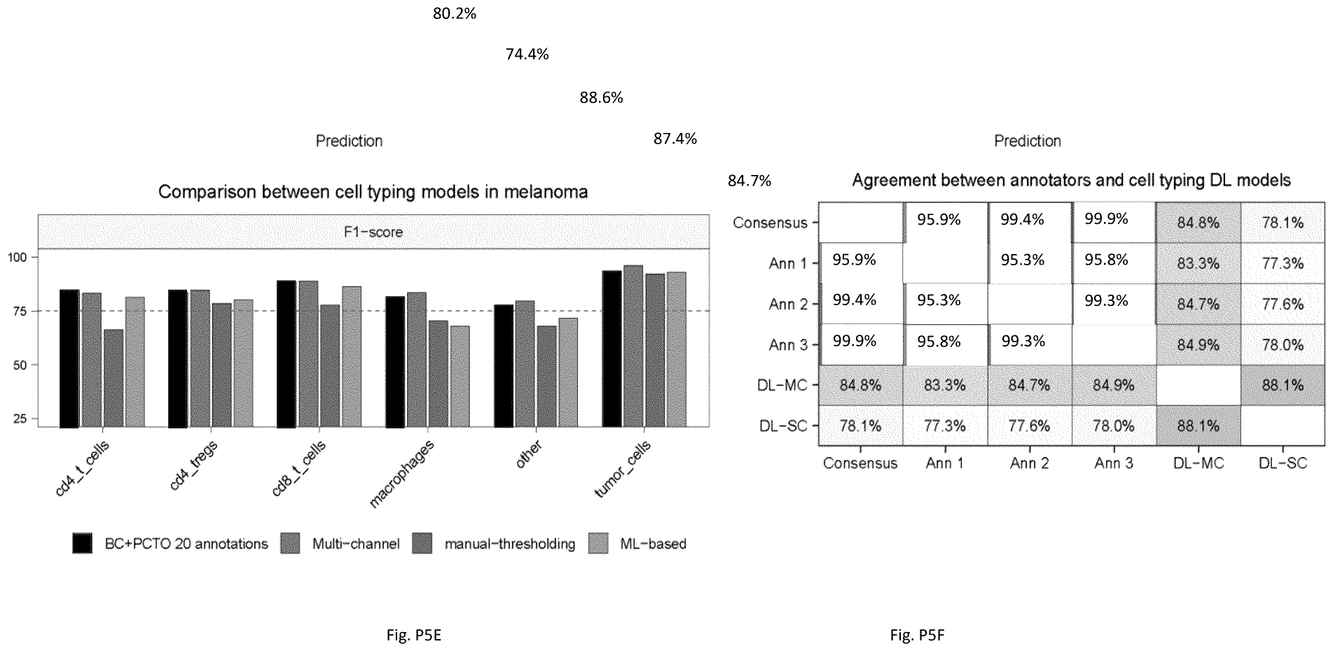

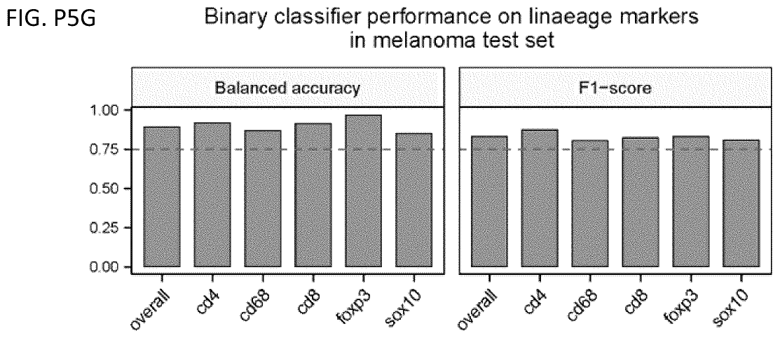

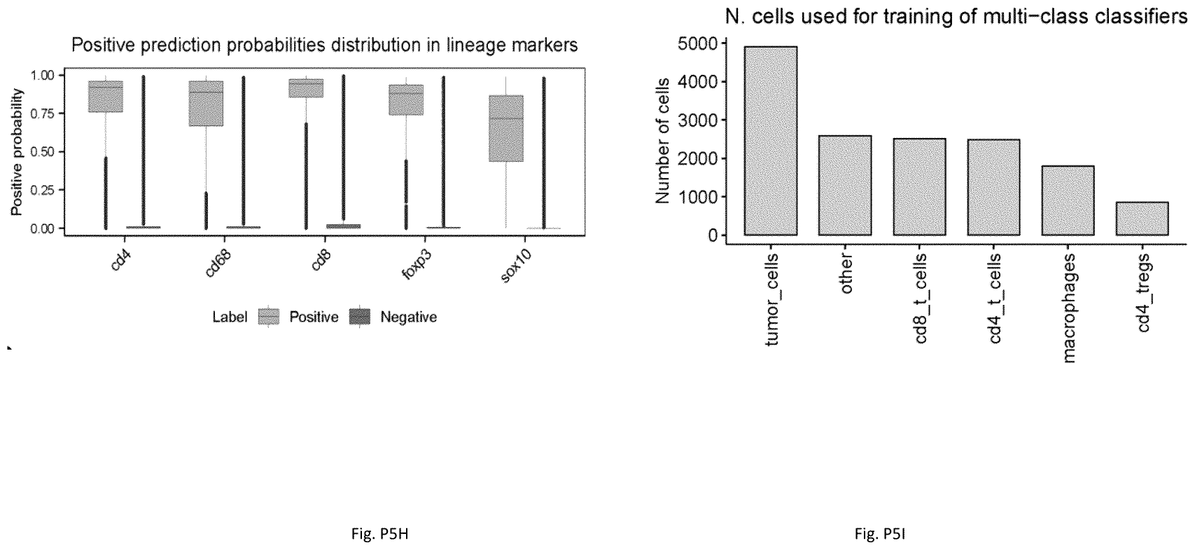

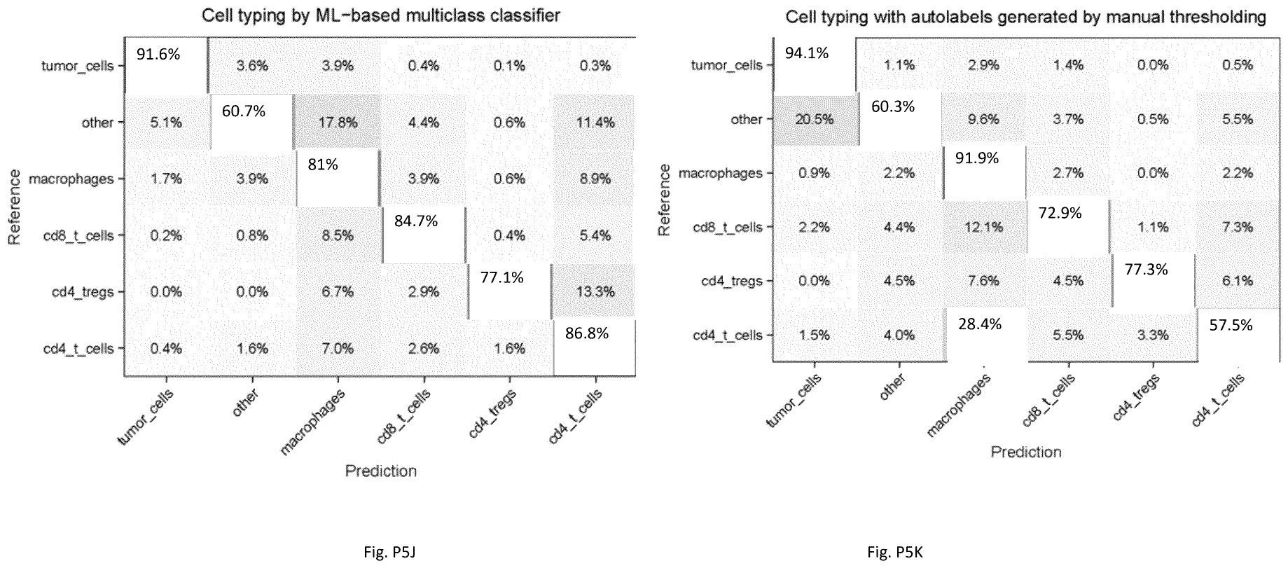

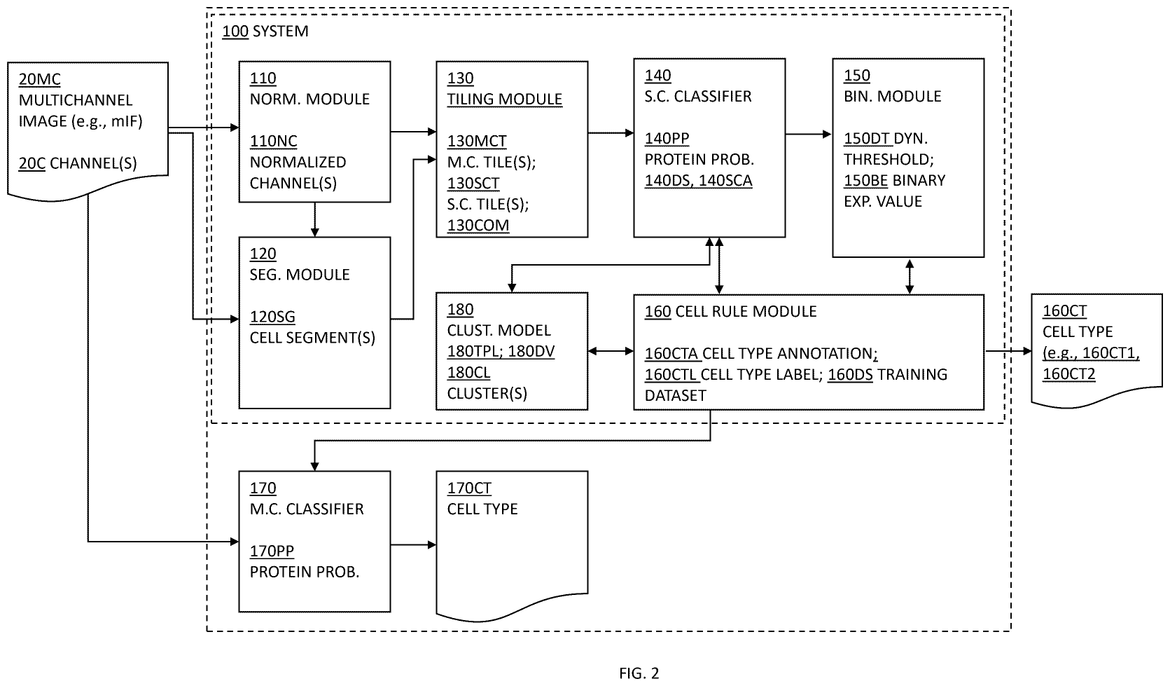

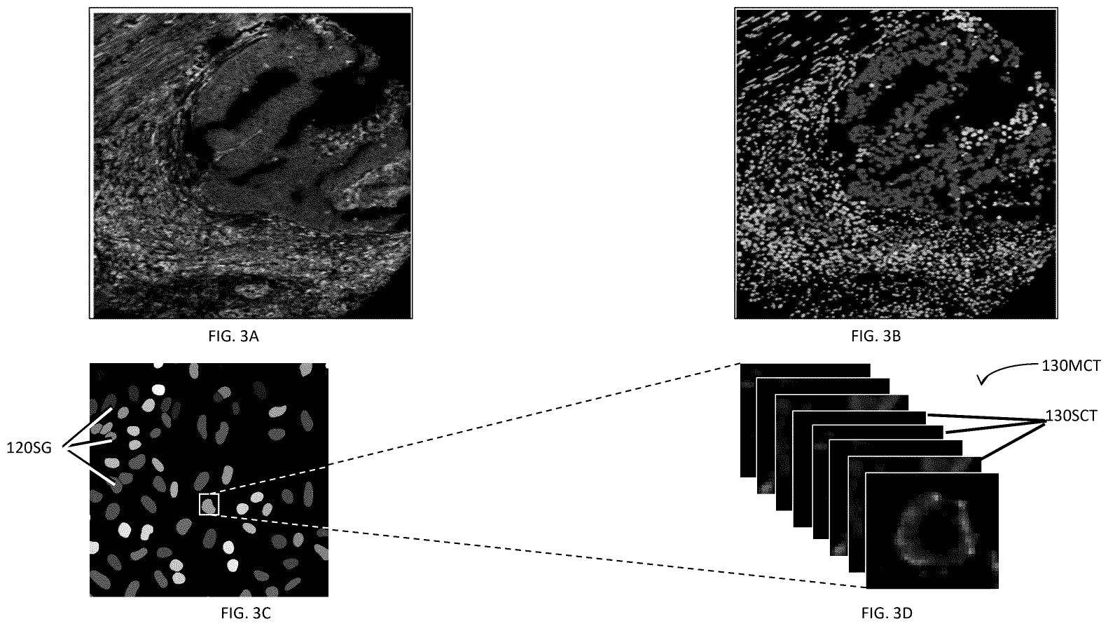

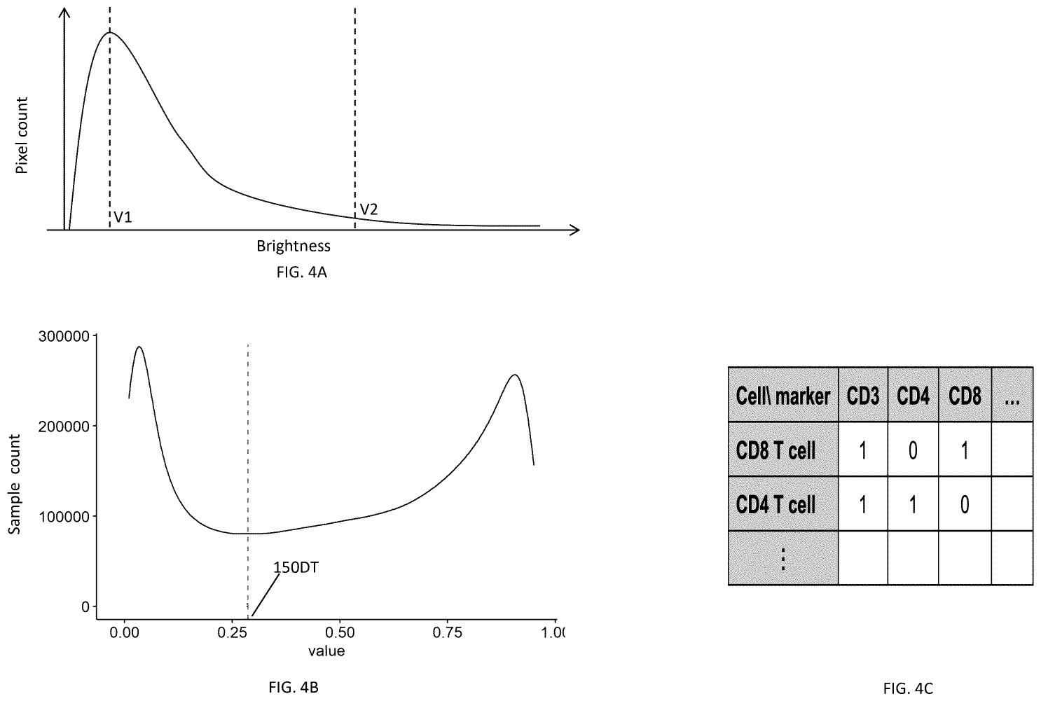

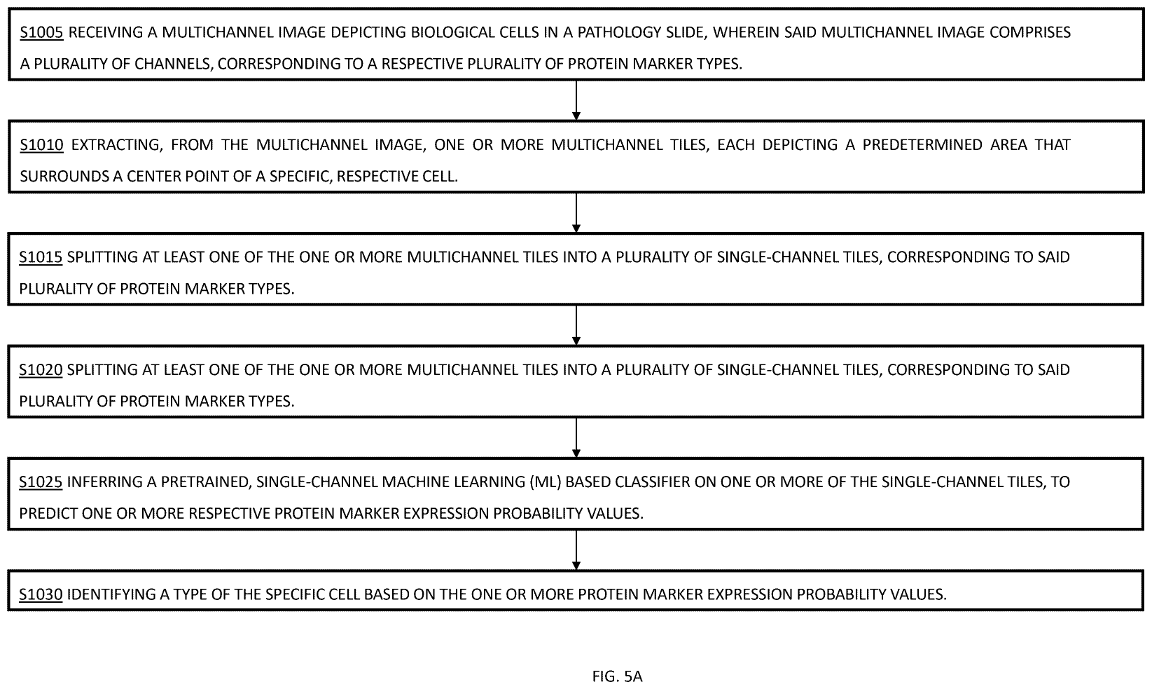

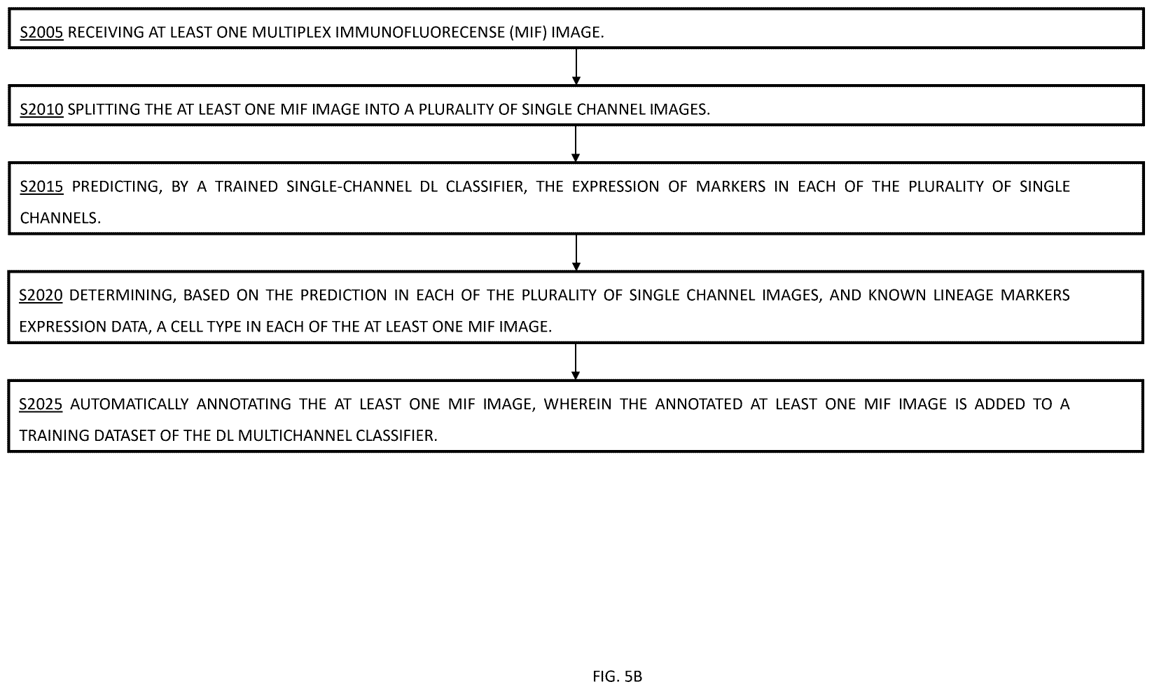

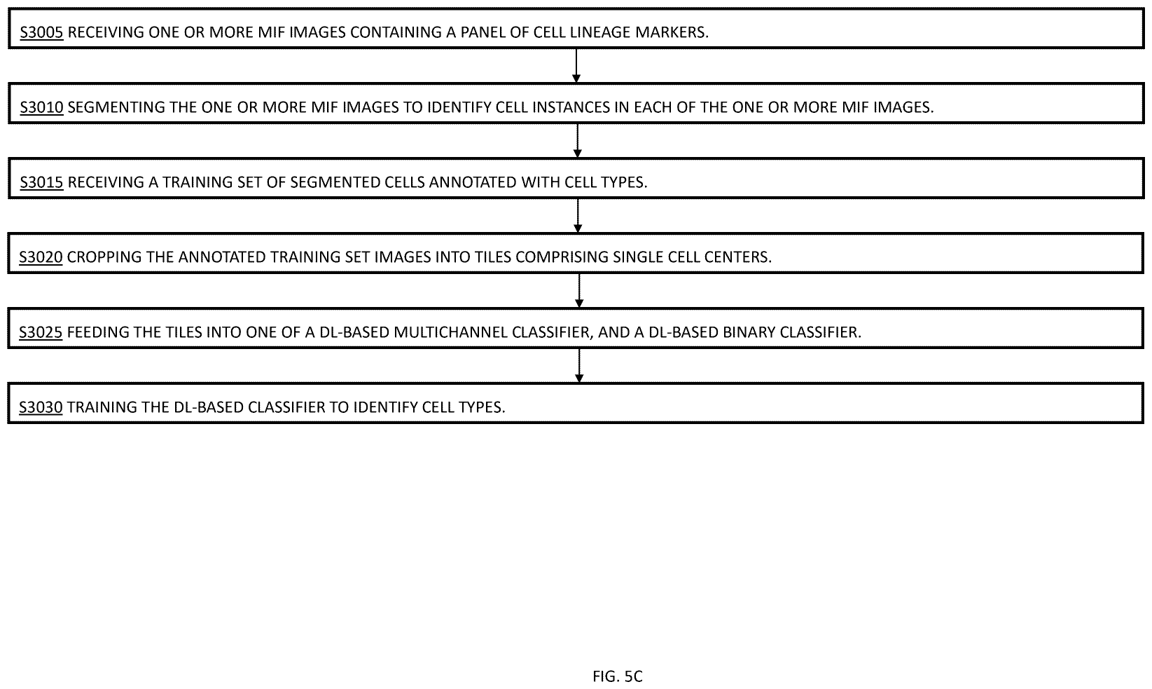

Reference is now made to FIG. 1, which is a block diagram depicting a computing device, which may be included within an embodiment of a system for classifying biological cells, according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to conduct methods as described herein.

Executable code 5 may be any executable code, e.g., an application, a program, a process, task, or script. Processor or controller 2 may execute code 5, possibly under control of operating system 3. For example, executable code 5 may be an application that may classify cells according to their types, as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data pertaining to multichannel images (e.g., mIF slide images) depicting biological cells may be stored in storage system 6 and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

The term neural network (NN) or artificial neural network (ANN), e.g., a neural network implementing a machine learning (ML) or deep learning (DL) function, may be used herein to refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. At least one processor (e.g., processor 2 of FIG. 1) such as one or more CPUs or graphics processing units (GPUs), or a dedicated hardware device may perform the relevant calculations.

Reference is now made to FIG. P2A which depicts an aspect of a system 100 for cell typing, and/or spatial features calculation, according to some embodiments of the invention.

As illustrated in FIG. P2A multichannel, or mIF images 20MC containing a panel of cell lineage markers may be fed into a DL-based cell segmenting module 120 to identify all cell instances.

A training set of segmented cells 120SG may be annotated with cell types (e.g., by expert annotators), which are then cropped into tiles (e.g., 25×25 μm² tiles, 20×20 μm² or the like) and may also be fed into a DL-based multichannel classifier 170 and/or a single-channel classifier 140.

When the tiles may be fed into DL-based multichannel classifier 170, the tiles are fed into the model as multichannel tiles 130MCT, and then classified into one of the annotated cell types 170CT.

When fed to the single-channel classifier 140, the tiles may first be split into single-channel tiles 130SCT, the ground truth for the single-channel classifier 140 may be based on the expected lineage marker expression (as further illustrated in FIG. P2B), for example, based on reports in the literature. The output of single-channel classifier 140 (e.g., positivity/negativity of an individual fluorescence channel), may be utilized to predict the positivity of previously unseen fluorescence channels of phenotypic markers, and determine their expression 150BE in the identified cells. The cell types 170CT and phenotypic marker expression 150BE can then be utilized to calculate a diversity of spatial features 190 that may be used to predict clinical outcomes. Additionally, or alternatively, The output of single-channel classifier 140 may be utilized to predict the positivity of previously unseen fluorescence channels of lineage markers, thereby enabling embodiments of the invention to identify cell types on which the model was not trained.

FIG. P2B depicts examples of lineage and immunomodulatory (phenotypic) markers stained in the publicly available dataset that were utilized in a study, as further described herein.

FIG. P2C is a confusion matrix for the DL multichannel classifier (170 in FIG. P2A) predicted cell types. In the study, the model achieved an overall accuracy of 92% (88.8%-99.6% balanced accuracy per class).

FIG. P2D shows a comparison of the balanced accuracy and F1 scores between DL multichannel classifier (170 in FIG. 2A) and a clustering-based cell-typing approach. The DL-based approach outperformed clustering for both metrics across all cell types (paired t-test; p=0.0023 and p<0.0001 for the comparison of balanced accuracy (left) and F1 scores (right) between the clustering-and DL-based approaches).

FIG. P2E shows a breakdown of the number of cell type annotations on the CRC CODEX dataset for each of the 12 classes. In FIG. P2F, a confusion matrix for the ML-based multichannel classifier (XGBoost), is shown. As may be evident, the ML-based multichannel classifier reached an overall accuracy of 88%.

FIG. P2G presents a comparison of the balanced accuracy and F1 scores between DL multichannel classifier 170 according to embodiments of the present invention, and an ML-based (e.g., XGBOOST) cell-typing approach. While the overall performance of the DL-based classifier was not significantly different, the F1-scores of B-cells (96% vs. 64%) and dendritic cells (74% vs. 35%) were higher for the DL-based approach (paired t-test; p=0.1and p=0.15 for the comparison of balanced accuracy and F1 scores, respectively).

Besides the utilization of high-plex data for identification of cellular subpopulations, a major advantage of multiplex imaging over current immunohistochemistry and IF imaging methods is that it allows to deduce cell functionality from phenotypic marker expression. Existing methods for the deduction of phenotypic marker positivity include either continuous quantification from segmented cell masks, which is influenced by both the segmentation quality and the stain intensity variation between slides, or manual thresholding, which is user-dependent, laborious, and is not robust between slides. Thus, there is a need for a model that can classify cell markers in a binary fashion, which will be robust across slides, markers, tissue type and imaging modalities.

Reference is now made to FIG. P3A which is an illustration of a single-channel binary classifier 300 that may be used, according to some embodiments, for predicting the positivity of cell state markers. Single-channel binary classifier 300 may be the same as single-channel classifier 140 of FIG. 2A.

According to some embodiments, once the positivity of cell state markers is predicted, rule-based logic (also referred to herein as cell rules 160) may serve for cell typing, e.g., based on the lineage and immunomodulatory (phenotypic) markers illustrated in FIG. P2B.

According to some embodiments, DL-based single-channel binary classifier 300 may utilize known marker expression (e.g., of FIG. P2B) to divide annotated multi-channel tiles 310, such as those used for training the DL cell classifier 170 in FIG. P2A, into binary single-channel annotated tiles 320.

DL binary classifier 300 may output a positive prediction probability 330 for each tile, which may be subject to threshold, to output a binary classification. In the study, as a baseline threshold, a 0.5 probability was used, to classify tiles as either negative or positive.

As illustrated in FIG. P3B, the model was evaluated on 19,000 single-channel lineage marker tiles in the 14 test tissue cores and exhibited excellent performance, reaching >90% overall accuracy and F1-score. However, per class examination of the F1-scores revealed F1-scores below 75% in 18% of lineage markers (3/17). Indeed, further inspection of the positive prediction probability distribution in positive and negative tiles demonstrated uneven distributions between markers and slides (FIGS. P3C and P3G). Thus, per-channel threshold optimization on the training set (PCTO), was performed, choosing thresholds which maximize F1-scores, while considering positive prediction probability variability between slides. While only a mild increase in overall F1 scores was observed, following per-channel threshold optimization to 92%, the overall accuracy increased to 97% and both CD31 and Na-K-ATPase demonstrated a significant performance boost in F1 scores after PTCO (76% vs. 89% and 77% vs. 87%, respectively, FIG. P3B). The inventors have examined the binary classifier model performance on 14 phenotypic markers in 14 test tissue cores, which the binary classifier was not trained upon. The model performance was evaluated on 1,600 single-channel phenotypic marker annotations (40-200 annotations per marker) and, using 0.5 as a threshold, observed a 91% accuracy, with F1 scores of above 80% in 93% of markers (FIG. P3D). Per channel threshold optimization with annotations from the train set tissue cores boosted the overall F1-score to 95%, which stemmed from a significant improvement in the F1-scores of markers with relatively low positive prediction probabilities such as LAG3 (89% to 98%), HLA-DR (82% to 97%) and PD-L1 (62% to 92%, FIG. P3D-P3E). To investigate the required number of annotations per channel for threshold optimization, the F1-scores of the 5 markers which improved with PTCO with increasing numbers of annotations was compared. In the study, only 20 annotations per channel were needed to achieve the most significant improvement in F1-scores, with additional annotations adding limited value (FIG. P3F). As the DL binary classifier 300 is robust across markers and slides, it could be used to accurately quantify a wide variety of cell state and lineage markers with a minimal number of added annotations to improve its performance in specific channels.

As provided in FIG. P3B, The model was evaluated on 19,000 single-channel lineage marker tiles in 14 test tissue cores. With a global threshold of 0.5 for predicting positive expression, the classifier reaches >90% overall accuracy and F1-score. Improved results are achieved with per channel threshold optimization (PCTO).

In FIG. P3C, The distribution of the probability of positivity across lineage markers is shown, for tiles with positive (red) and negative (blue) single-channel tiles. As may be realized, although the distribution is expected to differ significantly between positive and negative tiles, the result is highly variable across cell types.

In FIG. P3D, the DL binary classifier was evaluated on 1,600 annotated tiles of 14 phenotypic markers (40-200 annotations per marker) which the model had not been trained on. Using a default threshold of 0.5, the model achieved 91% accuracy, with F1 scores >80% in 93% of markers. The F1 score was improved to 95% when applying PCTO.

In FIG. P3E, the distribution of the probability of positivity across phenotypic markers, for tiles with positive (red) and negative (blue) single-channel tiles are shown, and in FIG. P3F, the F1 scores achieved for DL binary classifier prediction of various lineage cell markers using PCTO with 20, 50, 100 or 150 annotations, as compared to a default threshold of 0.5 (labeled ‘0 annotations’ in the plot) is shown. As may be seen in FIG. P3F, only 20 annotations were required in order to obtain a significant improvement in the F1 score.

FIG. P3G shows the distribution of the probability of positivity across lineage markers, for tiles with positive (red) and negative (blue) single-channel tiles, for different tissue cores.

As elaborated herein, the DL single-channel binary classifier 300 may be utilized for ‘label free’ cell typing.

The high performance of the DL single-channel classifier across lineage markers raises the question whether it can be utilized as a ‘label-free’ cell-typing tool. To create ‘auto-labels’, the inventors combined knowledge of expected marker expression within cell classes (FIG. P2F) with the DL binary classifier single-channel predictions and positive probabilities for each marker (FIG. P4A). Cells were assigned to a class if their binary marker predictions perfectly matched the expected binary marker expression of this class. Next, the inventors created a table of the mean positive probability for each marker within each cell class and then matched between unassigned cells and their closest mean positive probability vector. Comparison between auto-labels generated with the 0.5 threshold for marker positivity (‘label free’) and annotated cells within the test tissue cores, demonstrated an overall good performance with an 88.1% accuracy and F1-scores above 80% in 75% of cell classes. Using PTCO with 20 annotations for low performing channels (CD31, CD11c, αSMA and Na-K-ATPase), the inventors were able to increase the model's performance to 91% accuracy (FIG. P4B) while increasing the F1-scores for tumor (84.8% vs 90.5%), myofibroblasts (81.5% vs. 88%) and endothelial cells (86% vs. 91.5%) (FIG. P3C). Thus, the single-channel model reached a level of performance that was comparable to the multichannel classifier (FIG. P3C), with the exception of two cell classes; dendritic cells and other cell types (e.g., negative for all lineage markers), in which the F1-scores were lower.

To further corroborate the model's performance, the inventors qualitatively compared the four cell typing models: clustering-based, ML-based, DL multichannel classifier, and ‘auto-labels’ from the DL binary classifier. The models were blindly ranked and scored by expert annotators, based on their performance on the 14 tissue cores. The DL multichannel classifier was the top performing model, as reflected by 86% first-place votes and overall performance score of 3.8/5 (FIG. P3D). The second-best model was ‘auto-labels’ from the DL binary classifier, which received the majority of second-place votes, and an overall performance score of 3.3. Both the ML and clustering-based algorithms received a performance score that was lower than 3, and were only ranked as the top two performing models in 25% of the cases (FIG. P3D). Thus, the inventors demonstrate that DL-based cell-typing is superior to current approaches, and present a pipeline for cell-typing through single-channel predictions which reaches comparable results to that of the DL multichannel classifier, but requires significantly less annotations.

As elaborated herein, the inventors have experimentally validated the DL binary classifier 300 performance across markers, cancer indication and imaging modalities.

One of the main limitations of multiplex imaging analysis is that all current analysis methods do not allow for transfer learning between datasets. However, the DL binary classifier, according to embodiments of the present invention, is robust across markers, including markers it was not trained upon, and can be used for cell typing. To establish the robustness of the DL binary classifier across different antibodies, tumor types and imaging modalities the inventors stained 43 melanoma whole slide FFPE sections for 6 markers (CD8, CD4, FOXP3, CD68, SOX 10 and PD-L1) with PhenoImager technology (FIG. P5A). The images were divided into train (n=35) and test (n=9) sets. The binary classifier, which was trained on the CRC codex dataset, was deployed for ‘label free’ cell-typing to predict marker positivity for the lineage markers and deduce auto-labels (FIG. P5A). Without any annotations, the binary classifier reached F1-scores above 80% in all markers (FIG. P5G). However, a closer look at the positive prediction probabilities revealed lower positive prediction scores for SOX10 (FIG. P5H). Following threshold optimization for SOX 10 using only 20 annotations, the F1-score of SOX10 increased from 81% to 90%. In comparison to manual-thresholding, the current state-of-the-art method for establishing marker positivity, the binary classifier exhibited a better overall F1-score (85.7% vs. 78.5%), as well as better F1-scores in 80% of quantified markers (FIG. P5B). Hence, the binary classifier is robust across tumor indication and imaging modalities, outperforming current state-of-the-are methods for marker positivity determination.

Next, the inventors have compared the ‘label free’ cell-typing based on ‘auto-labels’ generated by the binary classifier or manual thresholding, with current state-of-the-art machine learning (ML) and deep learning (DL) methods for multiclass classification. Both a DL multichannel classifier and a ML-multichannel classifier were trained on over 15,000 cell type annotations from 35 training set slides (FIG. P5I). All models were evaluated on 2,800 annotations from 9 test set slides. Cell typing by DL-based models, according to embodiments of the present invention, were superior to both the ML based and manual thresholding-based models, as reflected by higher accuracy (87%, and 86% for the DL multi-and binary classifier (FIG. P5C and PSD) vs. 81% and 79% for the ML and manual-thresholding based classifiers, (FIGS. P5J, and P5K respectively). Moreover, a comparison of per-class F1-scores demonstrated similar F1-scores between the DL-based algorithm, with lower F1-scores in the ML and manual thresholding based algorithms (FIG. P5E). Lastly, the DL models', according to embodiments of the present invention, performance was compared with the inter-observer agreement rate between expert annotators. For this purpose, three annotators labeled a total of 1200 cells within identical exhaustive ROIs in 5 Whole Slide Images (WSIs) from the melanoma cohort. The inventors have observed >95% inter-observer agreement rate between all three annotators, establishing the validity of annotations as ground truth for multiplex imaging. The DL multichannel classifier exhibited an 85% agreement with the annotation consensus (defined as agreement between two annotators or more) while the ‘auto-labels’ generated by the DL binary classifier exhibited a 78% agreement with the consensus (FIG. P4F). Thus, the multiplex analysis pipeline demonstrated robustness across markers, tumor type and imaging modalities and can be deployed for a rapid and accurate analysis of multiplex imaging. While the DL multichannel classifier vastly surpassed current methodologies performance for cell typing, establishing new state-of-the-art performance benchmark, the DL binary classifier can be utilized for phenotypic marker quantification and demonstrated only a slight reduction in performance in comparison to the DL multichannel classifier, while relying on a miniscule number of annotations.

FIGS. P5A-P5F illustrate the application of the DL binary classifier, according to some embodiments, for cell-typing on a new tumor type and imaging modality. In FIG. P5A, 43 melanoma WSIs were stained with a panel of 6 markers with PhenoImager® technology. The DL binary classifier, trained on lineage markers of the CRC dataset, was deployed to create ‘auto-labels’ for 6 different classes in the unseen melanoma WSIs, based on knowledge of linear marker expression. The DL multichannel classifier was trained to classify cells on 21,000 annotations from the melanoma dataset. FIG. P5B shows a comparison of the F1 scores for the prediction of previously unseen lineage markers by the DL binary classifier with per-channel threshold optimization (PCTO), or by a manual thresholding. The binary classifier exhibited a better overall F1-score (85.7% vs. 78.5%), as well as better F1-scores in 80% of quantified markers.

FIG. P5C provides a confusion matrix of the ‘auto-labels’ predicted by the DL binary classifier for 6 different classes on unseen data. An 86% overall accuracy was achieved using this approach.

In FIG. P5D a confusion matrix of a DL multichannel classifier trained on the melanoma PhenoImager data is presented. The overall accuracy was 87%.

FIG. P5E is a comparison of F1 scores between the DL multichannel classifier (trained on the current dataset), DL binary classifier (trained on the CRC dataset), manual thresholding-based approach, and an ML-based classifier (trained on the current dataset) across classes. Lower F1 scores are observed for the ML and manual thresholding-based algorithms.

In FIG. P5F, The inter-observer agreement rate between expert annotators, and comparison to model predictions, is shown. Three experts independently annotated the same 1,200 cells within the melanoma PhenoImager dataset to establish the validity of the annotations. This was further compared to the predictions of the DL multichannel classifier and the DL binary classifier ‘auto-labels’ (trained on the CRC dataset). Over 95% agreement was observed between the annotators, and an 85% and 75% agreement with the annotation consensus was observed for the DL multichannel classifier and binary classifiers, respectively.

In FIG. P5G performance of the DL binary classifier (balanced accuracy and F1 scores), trained on the CRC dataset on lineage markers from an unseen melanoma dataset, across all lineage markers, is presented. In the absence of any annotations, the binary classifier performed well, reaching F1-scores >80% for all markers.

FIG. P5H shows the distribution of the probability of positivity across lineage markers, for tiles with positive (red) and negative (blue) single-channel tiles. It can be seen that the difference between the positive/negative distributions is less apparent for SOX10, where lower positive prediction scores are observed.

FIG. P5I is a breakdown of the number of cell type annotations on the melanoma PhenoImager dataset for each of the 6 classes. FIG. P5J is a confusion matrix fan ML-based multichannel classifier (XGBoost) trained on the melanoma PhenoImager dataset, which reached an overall accuracy of 79%, and FIG. P5K is a confusion matrix of the cell-typing produced by a manual thresholding approach, considered to be the current state-of-the-art (see Methods), which achieved an overall accuracy of 81%.

The spatial organization of cells in the iTME has an essential role in the process of tumor formation and immune system evasion. mIF imaging of tissue biopsies using recently developed tools, such as CODEX, has emerged as a powerful tool for iTME analysis that could potentially be used to predict clinical outcomes in cancer patients, including response to immunotherapy and overall survival. However, the analysis of multiplex images suffers from several limitations including inaccurate cell-typing, which is mainly achieved through manual thresholding and clustering-based methods. These methods are laborious, user-dependent, and do not support transfer learning between imaging modalities and antibody panels, which makes them hard to implement as a routine tool for translational and clinical research. To overcome these challenges the inventors developed a deep learning pipeline for the analysis of mIF images that can be generalized across tissue types, markers and imaging modalities.

The pipeline may utilize both multi-channel and single-channel deep learning classifiers and may achieve a high accuracy of over 90% in classifying cells, as compared to ˜65-80% using manual thresholding, clustering or machine learning-based cell-typing methods. One of the features that makes this pipeline unique is the binary single-channel classifier which is agnostic to marker type and can accurately classify markers that it was not trained upon. Thus, it can be utilized for both phenotypic marker classification and cell typing, as it identifies cell classes by relying on expected marker expression while using minimal annotations. As a result, this novel mIF analysis pipeline is significantly faster and more robust across markers and slides, as compared with other methods. Indeed, the model reached an overall accuracy of >95% both in classifying lineage markers that it was trained on and in classifying phenotypic markers which it was not trained upon. More importantly, the DL binary classifier demonstrated robustness across different antibodies, tumor types and imaging modalities-while the binary classifier was trained on CODEX CRC dataset, it showed high accuracy (86%) when tested on melanoma sections stained with PhenoImager imaging technology, with minimal addition of annotations. Lastly, the inventors demonstrate a very high inter-observer agreement rate between expert annotators (>95%), which validates that annotations should be used as ground truth for multiplex imaging. The DL-multichannel classifier exhibited high agreement rate with the annotators consensus (85%), again establishing it as state-of-the-art benchmark for cell typing. Taken together, the inventors exhibit a novel DL pipeline for multiplex imaging cell typing, demonstrating high accuracy and a 1.5-fold improvement over current cell typing methods, and robustness across markers, tumor type and imaging modalities. Thus, it can potentially be used for a rapid and accurate analysis of multiplex imaging.

For model generation, two multiplex imaging datasets were used. The first is a publicly available CODEX dataset7, consisting of 140 tissue cores from 35 colorectal cancer (CRC) patients, stained with 56 protein markers and matched H&E slides. The images were downloaded and annotated by expert annotators, under the supervision of expert pathologists. Above 7,000 cell annotations from 57 tissue cores were used as a training set for training of the DL and ML classifiers. 1,800 annotations from 14 test cores, which the models were not trained upon, were used for performance evaluation of the models. Moreover, over 1600 annotations of positive and negative cells for 14 phenotypic markers (FIG. 2B) on 14 test cores were used as a test set for the DL binary classifier performance. A second cohort, consisting of 44 whole slide images (WSIs) of melanoma cancer patients from Sheba medical center, was stained with 6 protein markers (FIG. P4A) and captured with PhenoImager® imaging system (Akoya Biosciences). Over 15,000 cell type annotations from 35 training set slides were used as a training set, while 2,800 annotations from 9 test set slides were used for model evaluation.

Multi-instance cell segmentation was performed using a deep learning model. Nuclear segmentation was based on the DAPI and Hoechst channels (for the CRC and melanoma datasets, respectively), and whole cell segmentation was based on the sum of all available membranous and cytoplasmic channels. Further post-processing was performed to match nuclear and whole cell masks, allowing to remove segmented cells that do not contain nuclei, merge the nuclei of multinucleated cells and split any nuclei assigned to multiple cells. In addition, a membranal segmentation mask was extracted by subtracting each nuclear mask from its matched whole cell mask, and then regularizing it by a ring around the nucleus.

Convolutional deep neural networks for cell typing and phenotypic markers quantification.

As input for the model 54×54-pixel (20 μm²) tiles were cropped around the center point of all annotated cell segmentation instances. The tiles were then normalized and scaled between 0 and 1. All models were trained based on Nucleai Ltd deep learning infrastructure, and were trained for at least 500 epochs. For the DL-multichannel classifier, the 54×54-pixel tiles were fed into the model as multichannel images. For the CRC dataset, multi-channel tiles consisting of 15 lineage markers (FIG. 2B) were inputted to the model, whereas for the melanoma dataset multi-channel tiles consisting of 5 lineage markers (FIG. P4A) were inputted. For the single-channel classifier (DL binary classifier), the tiles were split into single-channel images, and the ground truth per channel was determined via the known marker expression table as elaborated herein (e.g., in relation to cell rule module 160 of FIG. 2). Both the multiclass classifier 170 and the binary classifier's 140 predict expression probabilities (e.g., 140PP/170PP respectively). For the multichannel classifier 170, prediction probabilities 170PP are converted to cell types 170CT by assigning the cell type with maximal prediction probability to each identified cell. For the binary classifier 140, cells above a certain threshold are deemed positive. The threshold can be set to 0.5 for all channels or adjusted based on positive or negative tile annotations (per-channel thresholding optimization; PTCO). For subsequent cell-typing from single-channel binary classification of lineage markers (‘auto-label’ deduction), the expected marker expression tables were applied to the threshold channels.

The segmentation masks of cells were used to calculate the mean nuclear and membranous fluorescence intensity per channel for all annotated cells instances in the CRC dataset. These features were then Yeo-Johnson normalized to approximate normal distribution and scaled between 0 and 1. A multiclass cell XGBoost classifier 170 was hyperparameter optimized using a cross-validated randomized search. Each sample was assigned a weight based on the square root of the class incidence (with the rare dendritic cell upweighted by v5x).

For cell-typing by manual thresholding, 5 ROIs in 34 WSI from the melanoma dataset were spectrally unmixed using inForm® software v6.4.2 (Akoya Biosciences), and analyzed with the HALO® image analysis platform (Indica Labs), using the Highplex FL module. In addition, spectral auto-fluorescence reduction was performed from an unstained but rehydrated slide which was scanned under identical conditions. Following identification and segmentation of ˜665,000 cells, the positivity for each marker was determined by an algorithm that was trained on the positive control tonsil sample to identify the intensity threshold within the appropriate cell compartment. All tissue samples were examined to ensure that the algorithm identified each marker accurately, and in some cases, a manual adjustment was required to optimize the thresholding of specific channels.

All models were evaluated on test slides that were not seen during training. The inventors considered annotations by expert annotators as the ground truth, and performance metrics such as accuracy, balanced accuracy and F1-scores were calculated for each model. To qualitatively evaluate the models trained on the CRC CODEX dataset, a thorough review was performed under the guidance of experienced pathologists, and each model was given a score between 1-5, per WSI. The scoring was based on the percentage of overall cell detection for each model: 0-20, 20-40, 40-60, 60-80, 80-100 (1-5 levels). If a cell class was over-detected or under-detected, a point was deducted from the overall score. Additionally, all models were ranked from top to bottom according to their performance on each slide.

To assess the consistency of cell annotations and model performance, the inventors conducted an independent agreement test between three expert annotators. The test set consisted of approximately 1200 cells per annotator, from exhaustive ROIs in 5 melanoma WSIs images. The consensus cell-typing was decided by the majority vote of annotators.

Reference is now made to FIG. 2, which depicts a system 100 for classifying cells depicted in a multichannel image (e.g., mIF), according to some embodiments of the invention. System 100 and components of system 100 depicted in FIG. 2 may be the same as respective system 100 and components of FIG. P2A.

According to some embodiments of the invention, system 100 may be implemented as a software module, a hardware module, or any combination thereof. For example, system 100 may be or may include a computing device such as element 1 of FIG. 1, and may be adapted to execute one or more modules of executable code (e.g., element 5 of FIG. 1) to classify depicted cells according to their type, as described herein.

As shown in FIG. 2, arrows may represent flow of one or more data elements to and from system 100 and/or among modules or components of system 100. Some arrows have been omitted in FIG. 2 for the purpose of clarity.

FIG. 3A depicts an example of a multichannel or mIF image, where each channel may represent (e.g., by a unique color) an expression of a respective protein marker type, as known in the art.

According to some embodiments, system 100 may receive (e.g., via input device 7 of FIG. 1) a multichannel image 20MC (e.g., an mIF image) depicting biological cells in a pathology slide. Multichannel image 20MC may include a plurality of channels 20C, corresponding to a respective plurality of protein marker types. An example of such an mIF image is shown in FIG. 3A, where the plurality of protein marker types are manifested by respective colors.

It may be appreciated that variations in the process of WSI, such as in dying of the examined slide and image acquisition, may produce artifacts acquired multichannel images 20MC. Therefore, embodiments of the invention may include a normalization module 110, adapted to apply channel-level 20C normalization of the acquired mIF image 20MC.

FIG. 4A is a schematic graph showing an example of a brightness histogram of pixel intensity values in a specific channel of a multichannel image, according to some embodiments of the invention.

According to some embodiments, for one or more (e.g., each) channel 20C, normalization module 110 may calculate a brightness histogram representing distribution of pixel intensity (also referred to as brightness) in channel 20C. A heuristic example for such a histogram is provided in FIG. 4A, where levels of brightness are plotted against respective quantities of pixels. Normalization module 110 may calculate normalized intensity values of the channel's 20C pixels based on this distribution.

For example, normalization module 110 may identify a first pixel intensity value (denoted V1), which corresponds to a peak of the brightness histogram. It has been experimentally observed that this peak value typically represents a background region depicted in the channel 20C. Normalization module 110 may then identify a second pixel intensity value (denoted V2), which directly exceeds the intensity of a predetermined quantile (e.g., 90%) of cells depicted in the multichannel image. The term “directly” is used in this context to indicate that V2 may be a minimal brightness value that still exceeds brightness of the predetermined quantile (e.g., 90%) of channel 20C pixels.

Normalization module 110 may subsequently normalize intensity (e.g., brightness) values of pixels of the channel 20C according to the range between the first pixel intensity value V1 and the second pixel intensity value V2.

For example, normalization module 110 may produce normalized channel images 110NC, such that intensity of pixels of images 110NC populate the range between V1 and V2.

In another example, intensity of pixels in channels 20C may be defined between a minimal numerical representation value (e.g., 0) and a maximal numerical representation value (e.g., 255). Normalization module 110 may produce normalized channel images 110NC, such that (i) intensity of pixels equal to, or below intensity value V1 are assigned the minimal numerical representation value (e.g., 0), (ii) intensity of pixels equal to, or above intensity value V2 are assigned the maximal numerical representation value (e.g., 255), and (iii) intensity of pixels between V1 and V2 are stretched between the minimal (e.g., 0) and maximal (e.g., 255) numerical representation values.

In another example, normalization module 110 may produce normalized channel images 110NC, such that intensity of pixels of corresponding single-channel tiles 130SCT are in the range between the first pixel intensity value V1 the second pixel intensity value V2.

In yet another example, normalization module 110 may produce normalized channel images 110NC, such that (i) intensity of pixels of subsequent single-channel tiles 130SCT equal to, or below intensity value V1 are assigned the minimal numerical representation value (e.g., 0), (ii) intensity of pixels of subsequent single-channel tiles 130SCT equal to, or above intensity value V2 are assigned the maximal numerical representation value (e.g., 255), and (iii) intensity of pixels of subsequent single-channel tiles 130SCT that are between V1 and V2 are stretched between the minimal (e.g., 0) and maximal (e.g., 255) numerical representation values.

FIG. 3C depicts an example of segmentation of a multichannel image, according to some embodiments of the invention.

According to some embodiments, system 100 may include a segmentation module 120 adapted to apply a segmentation algorithm on multichannel image 20MC and/or on the normalized version (e.g., normalized channels 110NC) of multichannel image 20MC, to produce at least one cell segment 120SG. Segment 120SG may represent a biological cell that is depicted in multichannel image 20MC. An example of such segments 120SG of biological cells may be viewed in FIG. 3C.

FIG. 3D depicts an example of a multichannel tile, that may be comprised of a plurality of single-channel tiles, according to some embodiments of the invention.

As shown in FIG. 2, system 100 may further include a tiling module 130, configured to extract multichannel tiles 130MCT and/or single-channel tiles 130SCT from multichannel image 20MC and/or from the normalized version (e.g., normalized channels 110NC) of multichannel image 20MC. Each tile 130SCT/130MCT may depict a predetermined area that surrounds a center point of a specific, respective biological cell segment 120SG.

For example, tiling module 130 may calculate a center of mass 130COM of a segment 120SG in multichannel image 20MC, and then define the multichannel tile 130MCT as an area (e.g., a rectangle) of pixels surrounding the calculated center of mass 130COM. Tiling module 130 may subsequently split at least one (e.g., each) multichannel tile 130MCT into a plurality of single-channel tiles 130SCT, corresponding to the plurality of protein marker types of channels 20C.

Additionally, or alternatively, tiling module 130 may calculate a center of mass 130COM of a segment 120SG in a normalized channel 110NC, and then define the single-channel tile 130SCT as an area (e.g., a rectangle) of pixels surrounding the calculated center of mass 130COM.

As shown in FIG. 2, system 100 may include a single-channel, ML based classifier 140, which may be the same as classifier 140 of FIG. P2A. According to some embodiments, system 100 may infer a pretrained version of single-channel ML classifier 140 on one or more of the single-channel tiles 130SCT, to predict one or more respective protein marker expression probability values 140PP.

FIG. 3B depicts an example of classification of cells depicted in the multichannel or mIF image of FIG. 3A, according to respective cell types, as obtained by embodiments of the invention.

As elaborated herein, system 100 may subsequently utilize protein marker expression probability values 140PP, e.g., by applying rule-based logic to probability values 140PP, to identifying a type 160CT of specific biological cells. An example of such classification of cells, depicted in image 20MC, based on their types (also referred to herein as cell “typing”) is shown in FIG. 3B.

According to some embodiments, system 100 may obtain (e.g., via input device 7 of FIG. 1) a training dataset 140DS. Training dataset 140DS may include (i) a plurality of training single-channel tiles 130SCT, and (ii) associated single-channel tile annotations 140SCA. Annotations 140SCA may include an indication of existence of a protein marker (e.g., any protein marker), pertaining to specific, associated single-channel tiles.

Additionally, single-channel tile annotations 140SCA may be devoid of indication of specific protein marker types in the associated single-channel tiles. In other words, annotations 140SCA may indicate that a protein marker is expressed in a specific tile, but also purposefully not include indication of the type of the expressed protein marker.

System 100 may use the single-channel tile annotations 140SCA to train the single-channel ML classifier so as to predict protein marker expression probability 140PP values of respective training single-channel tiles. For example, and as known in the art, system 100 may utilize a training scheme (e.g., a backward propagation scheme), to train classification model 140 based on the training single-channel tiles 130SCT, while using the single-channel tile annotations 140SCA as supervisory information.

In other words, based on its training, ML based classification model 140 may map between characteristics of single-channel tiles 130SCT (e.g., brightness values, coordinates values, morphological features, etc.) in an image of a single-channel tile 130SCT, and a corresponding prediction of protein marker expression probability 140PP.

In a subsequent, inference stage, classification model 140 may be configured to receive data representing one or more instant single-channel tiles 130SCT. Based on the training, classification model 140 may classify, or predict protein marker expression probability 140PP in the instant single-channel tiles 130SCT.

It may be appreciated that the training stage of classification model 140 may precede a subsequent inference of pretrained classification model 140 on data originating from incoming images 20MC. Additionally, or alternatively, the training and inference stages of classification model 140 may be intermittent, or repetitive, allowing system 100 to refine the training of classification model 140 over time.

As explained herein, by omitting the protein marker type information from training dataset 140DS (e.g., from single-channel tile annotations 140SCA), classifier 140 be trained to be agnostic to the protein marker type information, but nevertheless predict the expression of a (e.g., any) protein marker in an instant single-channel tile 130SCT. This quality has been experimentally shown to provide an improvement over currently available methods and systems for cell typing:

Currently available multichannel classification methods are very rigid, in a sense that they must be uniquely trained and adapted to handle specific combinations (e.g., panels) of dyes and protein marker types. In contrast, having classifier 140 agnostic to the protein marker type information may allow easy, and robust scaling of system 100, to classify cell types based on previously unseen panels or combinations of protein marker types.

As shown in FIG. 2, system 100 may include a binarization module 150 and a cell rule module 160. Binarization module 150 may apply a first logic, to produce binary (e.g., Yes/No) prediction 150BE of protein marker expression in a single-channel tile 130SCT, based on the predicted protein marker expression probability 140PP. Cell rule module 160 may, in turn, apply a second logic, to determine a type of a specific cell depicted in the single-channel tile 130SCT.

FIG. 4B is a schematic graph showing an example of distribution of protein marker expression probability values in a cohort of cells, according to some embodiments of the invention.

According to some embodiments, binarization module 150 may, for one or more (e.g., each) single-channel tile 130SCT, calculate a dynamic decision threshold value 150DT. For example, training dataset 140DS may typically have a bi-modal distribution, where samples (e.g., specific single-channel tile 130SCT) may represent cells that either express protein markers, or do not do so.

An example of such bi-modal distribution is shown in the example of FIG. 4B, where one peak may indicate positive expression of a (e.g., any) protein marker, and another peak may indicate lack of expression of a (e.g., any) protein marker. As shown in the example of FIG. 4B, training dataset 140DS may detect a minimum (e.g., global minimum) value in the bi-modal distribution of protein markers' expression as the dynamic decision threshold value 150DT. The term “dynamic” may be used in this context to indicate that threshold value 150DT may be updated over time, e.g., as new images 20MC arrive and/or vary between different channels, slides, protein marker types, and the like.

Binarization module 150 may subsequently apply the dynamic decision threshold value 150DT to the predicted protein marker expression probability value 140PP, to determine binary protein marker expression value 150BE, e.g., where a probability value 140PP below threshold value 150DT would yield a negative binary expression value 150BE, and a probability value 140PP above threshold value 150DT would yield a positive binary expression value 150BE.

FIG. 4C is a schematic example of a table, implementing cell-level, rule based logic, showing an example of distribution of protein marker expression probability values in a cohort of cells, according to some embodiments of the invention.

Cell rule module 160 may apply rule-based logic on binary protein marker expression values 150BE of one or more single-channel tiles 130SCT, e.g., pertaining to a single multichannel tile 130MCT, to determine a type 160CT (e.g., 160CT1) of a specific cell depicted in that multichannel tile 130MCT.

For example, cell rule module 160 may be, or may implement a data structure (e.g., a table, a linked list, etc.) that may associate, based on prior knowledge, between specific cell types and respective expected expression of protein markers. An example for such association is shown in the example of FIG. 4C, where: (a) CD8 cells are expected to express CD3 and CD8 protein markers, and not to express CD4 protein markers; and (b) CD4 cells are expected to express CD3 and CD4 protein markers, and not to express CD8protein markers.

Pertaining to this example, (a) binary protein marker expression values 150BE of {CD3=1, CD4=0, CD8=1} would cause cell rule based logic 160 to yield a cell type 160CT1=CD8; and (b) binary protein marker expression values 150BE of {CD3=1, CD4=1, CD8=0} would cause cell rule based logic 160 to yield a cell type 160CT1=CD4.

According to some embodiments, system 100 may employ cell rule-based module 160 to produce single-channel tile annotations 140SCA automatically, to obtain training dataset 140DS, based on predefined cell type knowledge.

For example, system 100 may receive (e.g., via input device 7 of FIG. 1) or obtain (e.g., from tiling module 130) a specific multichannel tile 130MCT of a multichannel image 20MC. System 100 may also receive (e.g., via input device 7 of FIG. 1) a respective, associated cell type annotation 160CTA. Cell type annotation 160CTA may indicate a type of a biological cell depicted in the specific multichannel tile 130MCT.

Cell rule module 160 may subsequently apply the rule-based logic on the received or obtained cell type annotation 160CTA, in the opposite direction, to obtain a plurality of single-channel tile annotations 140SCA. In such embodiments, one or more (e.g., each) single-channel tile annotation 140SCA may pertain to a specific channel 20C of the specific multichannel tile 130MCT, and may represent protein marker expression 150BE in that channel 20C.

Pertaining to the example of FIG. 4C, a cell type annotation 160CTA=CD8 would yield a single-channel tile annotation 140SCA that includes the values of {1, 0, 1} for channels {CD3, CD4, CD8} respectively. In another example, a cell type annotation 160CTA-CD4 would yield a single-channel tile annotation 140SCA that includes the values of {1, 1, 0} for channels {CD3, CD4, CD8} respectively.

By employing this opposite extraction of single-channel tile annotation 140SCA based on cell type annotation 160CTA, embodiments of the invention may exhibit several improvements over conventional practice of WSI annotation:

Data pertaining to specific layers or channels of mIF images may be occluded or unclear, and may be difficult to ascertain. However, an expert annotator may possess knowledge and intuition regarding the morphology and position of specific cell types, making it easier to infer their specific profile of protein expression. Therefore, cell-based annotation (rather than protein expression based annotation) may prove to be more accurate for many applications of assistive diagnosis technology.

Additionally, cell rule module 160 may use a single cell-based annotation, to produce a plurality of protein expression based, single-channel tile annotation 140SCA, thereby improving the efficiency and practicality of embodiments of the invention, in relation to currently available, comparable methods.

It may be appreciated that applying rule-based logic 160 on binary protein marker expression values 150BE to determine cell type 160CT1 will be most effective with cells that perfectly match the expected marker expression of single cell types. Embodiments of the invention may apply additional logic to mitigate cases in which such matching does not exist.

For example, system 100 may repeat the inference of single-channel classifier 140 with single-channel tiles 130SCT originating from a plurality of multichannel tiles 130MCT, to obtain or predict a respective plurality of protein marker expression probability values 140PP. System 100 may also repeat the identification of cell types 160CT1, based on the plurality of protein marker expression probability values 140PP, as elaborated herein, to determine or classify cells depicted in the plurality of multichannel tiles 130MCT according to their types 160CT1. System 100 may subsequently cluster the plurality of multichannel tiles 130MCT according to their determined cell types 160CT1, to form a clustering model 180. Clustering model 180 may include a plurality of groups or clusters 180CL, represented in a multidimensional marker expression probability space. Each cluster 180CL of the clustering model 180 may correspond to, or be associated with a specific cell type 160CT (e.g., 160CT1).

System 100 may subsequently utilize clustering model 180 to associating new cells, e.g., cells depicted in multichannel tiles 130MCT that do not exactly match cell type patterns and profiles of cell rule-based logic, to appropriate clusters (and respective cell types 160CT).

System 100 may subsequently obtain a tuple 180TPL data element, which may include protein marker expression probability values 140PP, of a corresponding multichannel tile 130MCT (e.g., a depicted biological cell) of interest. The multichannel tile 130MCT/cell of interest may, for example, be one whose binary protein marker expression values 150BE do not exactly match the rule-based logic of cell rules module 160.

Based on tuple 180TPL, system 100 may calculate one or more distance metric values 180DV, representing distances between the biological cell of interest and one or more clusters in the multidimensional marker expression probability space. For example distance metric value 180DV may define a cosine distance between protein marker expression probability values 140PP of tuple 180TPL, and protein marker expression probability values 140PP of multichannel tile 130MCT/cells in clusters 180CL of clustering model 180.

System 100 may subsequently associate the multichannel tile 130MCT/biological cell of interest to a cluster 180CL of clustering model 180 based on the calculated distance metric values 180DV, thereby assigning a cell type 160CT (e.g., 160CT2) to the new multichannel tile 130MCT/cell of interest.

For example, system 100 may identify a specific multichannel tile 130MCT (a specific depicted cell) having minimal cosine distance value 180DV from probability values 140PP of tuple 180TPL. System 100 may then assign the same cell type 160CT (e.g., 160CT2) to the new incident multichannel tile 130MCT/cell of interest, as the cell type 160CT (e.g., 160CT1) of the identified specific multichannel tile 130MCT (the specific depicted cell).

As shown in FIG. 2, system 100 may include a multichannel classification model (or “classifier”) 170, which may be the same as DL cell classifier 170 of FIG. P2A. As elaborated herein, system 100 may utilize single-channel classification 140 and the rule-based logic of cell rules module 160 to produce cell typing 160CT. Additionally, or alternatively, system 100 may exploit cell typing 160CT as a label (denoted cell type label 160CTL) for training multichannel classification model 170.

In other words, system 100 may include, or obtaining (e.g., via input 7 of FIG. 1) an initial version of multichannel ML based classification model 170, configured to classify an example of a multichannel tile according to a type of a biological cell depicted in the example of the multichannel tile. The term “initial version” may be used in this context to indicate that multichannel classification model 170 may include, for example a NN architecture, which may not yet be fully trained to classify cells depicted in incident multichannel tile 130MCT in a satisfactory manner.

System 100 may receive (e.g., via input 7 of FIG. 1) or obtain (e.g., via tiling module 130) an instant multichannel tile, which may include a plurality of single-channel tiles 130SCT. System 100 may infer single-channel ML based classifier 140 on one or more (e.g., each) of the single-channel tiles 130SCT of the instant multichannel tile 130MCT, to predict one or more respective protein marker expression probability values 140PP.

As elaborated herein, binarization module 150 may collaborate with single channel classifier 140 to produce binary expression versions 150BE of protein marker expression probability values 140PP.

Cell rule module 160 may subsequently produce a cell-type label 160CTL, representing a type of the cell depicted in the instant multichannel tile 130MCT based on the one or more protein marker expression probability values 140PP (e.g., based on the binary expression versions 150BE of protein marker expression probability values 140PP).

System 100 may then use cell type label 160CTL as supervisory information, to retrain multichannel ML based classification model 170, so as to predict a type 170CT of the biological cell depicted in the instant multichannel tile 130MCT.

According to some embodiments,, system 100 may obtaining an initial version of a multichannel ML based classification model 170, configured to classify an example of a multichannel tile 130MCT according to a type of a biological cell 170CT depicted in the example of the multichannel tile 130MCT. For example, the initial version multichannel classification model 170 may include an untrained, or partially trained NN architecture, consisting of a plurality of neural nodes. The terms untrained and semi-trained may be used in this context to indicate a ML model that may not yet provide classification of multichannel tile 130MCT with performance metrics that satisfy predefined performance requirements.

System 100 may obtain (e.g., via tiling module 130) an instant multichannel tile 130MCT that may include a plurality of single-channel tiles 130SCT, and may infer single-channel ML based classifier 140 on one or more of the single-channel tiles 130SCT of the instant multichannel tile 130MCT, to predict one or more respective protein marker expression probability values 140PP.

Cell rule module 160 may then produce a cell-type label 160CTL, representing a type of the cell depicted in the instant multichannel tile 130MCT, based on the one or more protein marker expression probability values 140PP. For example, cell rule module 160 may apply the cell rule table of FIG. 4C on the binary expression versions 150BE of protein marker expression probability values 140PP, to obtain the labels 160CTL of cell types.

System 100 may subsequently use cell type labels 160CTL as a training dataset 160DS of supervisory information, to retrain the multichannel ML based classification model (e.g., the NN architecture), by any appropriate training algorithm known in the art (e.g., a backward propagation based training algorithm), to predict a type 170CT of the biological cell depicted in the instant multichannel tile 130MCT.

FIG. 5A is a flow diagram showing an example of a method of classifying cell types in a multichannel image by at least one processor (e.g., processor 2 of FIG. 1), according to some embodiments of the invention.

As shown in step S1005, the at least one processor 2 may receive a multichannel image (e.g., 20MC of FIG. 2) depicting biological cells in a pathology slide. Multichannel image 20MC may include a plurality of channels 20C, corresponding to a respective plurality of protein marker types, e.g., where each channels 20C represents a unique protein marker type.

As shown in step S1010, the at least one processor 2 may employ tiling module 130 of FIG. 2, to extract, from multichannel image 20MC one or more multichannel tiles 130MCT. As elaborated herein (e.g., in relation to FIG. 2), each multichannel tile 130MCT may depict a predetermined area that surrounds a center point of a specific, respective, depicted cell.

As shown in step S1015, the at least one processor 2 may split at least one of the one or more multichannel tiles 130MCT into a plurality of single-channel tiles 130SCT (e.g., corresponding to the plurality of protein marker types of channels 20C).

As shown in step S1020, and elaborated herein (e.g., in relation to FIG. 2), the at least one processor 2 may infer a pretrained, single-channel ML based classifier (e.g., 140 of FIG. 2) on one or more of the single-channel tiles 130SCT, to predict one or more respective protein marker expression probability values 140PP.

As shown in step S1025, the at least one processor 2 may employ cell rule module 160 to identify a type 160CT of the specific, depicted cell, based on the one or more protein marker expression probability values 140PP. For example, cell rule module 160 may apply a rule-base table, such as that depicted in the example of FIG. 4C, on binary versions 150BE of probability values 140PP, to obtain cell type 160CT.

FIG. 5B is a flow diagram showing an example of a method of creating a training dataset for a DL multichannel classifier by at least one processor (e.g., processor 2 of FIG. 1), according to some embodiments of the invention.

As shown in steps S2005 and S2010, the at least one processor 2 may receive at least one multiplex mIF image 20MC, and may split the at least one mIF image 20MC into a plurality of single channel images 20C.

As shown in step S2015, the at least one processor 2 may employ a trained single-channel DL classifier (e.g., 140 of FIG. 2) to predict expression of markers 140PP in one or more (e.g., each) of the plurality of single channels 20C.

As shown in step S2020, and as elaborated herein (e.g., in relation to FIG. 2), the at least one processor 2 may subsequently determine, based on (a) the prediction 140PP in each of the plurality of single channel images 20C, and (b) known lineage markers expression data (e.g., as depicted in the example of FIG. 4C), a cell type (e.g., 160CT of FIG. 2) in one or more (e.g., each) of the at least one mIF image 20MC.

As shown in step S2025, and as elaborated herein (e.g., in relation to FIG. 2), the at least one processor 2 may then automatically annotate or label (e.g., 160CTL of FIG. 2) the at least one mIF image 20MC. The annotated at least one mIF image may be added to a training dataset 160DS, to train multichannel classifier 170 of FIG. 2.

FIG. 5C is a flow diagram showing an example of a method of training a deep learning (DL) pipeline for cell typing in multiplex imaging by at least one processor (e.g., processor 2 of FIG. 1), according to some embodiments of the invention.

As shown in step S3005, the at least one processor 2 may receive (e.g., via input device 7 of FIG. 1) one or more multiplex mIF images 20MC that may contain a panel of cell lineage markers.

As shown in step S3010, the at least one processor 2 may employ a segmentation module (e.g., 120 of FIG. 2) to segment the one or more mIF images 20MC to identify cell instances, or segments 120SG in at least one (e.g., each) of the one or more mIF images 20MC.

As shown in steps S3015, the at least one processor 2 may receive (e.g., via input device 7 of FIG. 1) a training set 160DS of segmented cells 120SG annotated, or labeled with cell types 160CTL.

As shown in steps S3020 and as elaborated herein, the at least one processor 2 may employ a tiling module (e.g., 130 of FIG. 2) to tile, or crop the annotated training set images 20MC into tiles 130MCT. Each tile 130MCT may include single cell centers, also referred to herein as centers of mass.

As shown in steps S3025 and S3030, the at least one processor 2 may feed, or provide tiles 130MCT as input into one of a DL-based multichannel classifier 170, and a DL-based binary classifier 140. The at least one processor 2 may then train at least one of DL-based multichannel classifier 170, and DL-based binary classifier 140 to identify cell types 160CT/170CT of biological cells depicted in the one or more mIF images 20MC.

Embodiments of the invention may include a practical application in the technological field of assistive diagnosis, e.g., to provide robust, and scalable analysis of multichannel images of pathology slides.

As elaborated herein, embodiments of the invention may purposefully, and counter-intuitively, train a single-channel classifier to predict existence of any (e.g., non-specific) protein markers in channels of multichannel images. By doing so, embodiments of the invention may categorize, or classify depicted cells according to their type, while (a) providing classification performance (e.g., F1) that is comparable to that of multiclass classifiers as known in the art, and (b) be scalable, and robust, to provide satisfactory cell type classification, based on unseen protein marker panels and/or unseen cell lineages, without any need to retrain the classifiers, and without need to obtain an appropriate training dataset.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of classifying cells by at least one processor, the method comprising:
receiving a multichannel image depicting biological cells in a pathology slide, wherein said multichannel image comprises a plurality of channels, corresponding to a respective plurality of protein marker types;
extracting, from the multichannel image, one or more multichannel tiles, each depicting a predetermined area that surrounds a center point of a specific, respective cell;
splitting at least one of the one or more multichannel tiles into a plurality of single-channel tiles, corresponding to said plurality of protein marker types;
inferring a pretrained, single-channel Machine Learning (ML) based classifier on one or more of the single-channel tiles, to predict one or more respective protein marker expression probability values, wherein the single-channel ML based classifier is agnostic to protein marker type information; and
identifying a type of the specific cell based on the one or more protein marker expression probability values.

2. The method of claim 1, wherein identifying a type of the specific cell comprises:
for at least one single-channel tile, (i) calculating a dynamic decision threshold value, and (ii) applying the dynamic decision threshold value on the protein marker expression probability value, to determine a binary protein marker expression value; and
applying rule-based logic on binary protein marker expression values of one or more single-channel tiles, to determine the type of the specific cell.

3. The method claim 2, further comprising:
repeating said inferring of claim 1 with single-channel tiles originating from a plurality of multichannel tiles, to obtain respective protein marker expression probability values;
repeating said identifying of claim 2 with cells depicted in the plurality of multichannel tiles, to determine respective cell types of the depicted cells; and
clustering the plurality of multichannel tiles according to their determined cell types, to form a clustering model in a multidimensional marker expression probability space, wherein each cluster of the clustering model corresponds to a specific cell type.

4. The method of claim 3, further comprising:
obtaining a tuple of protein marker expression probability values, representing a corresponding biological cell of interest;
based on said tuple, calculating one or more distance metric values, representing distances between the biological cell of interest and one or more clusters in the multidimensional marker expression probability space; and
associating the biological cell of interest to a cluster of the clustering model, based on the calculated distance metric values.

5. The method of claim 1, further comprising:
obtaining a training dataset comprising (i) a plurality of training single-channel tiles, and (ii) associated single-channel tile annotations; and
using the single-channel tile annotations to train the single-channel ML classifier so as to predict protein marker expression probability values of respective training single-channel tiles.

6. The method of claim 5, wherein the single-channel tile annotations (a) comprise indication of existence of a protein marker in the associated single-channel tiles, and (b) are devoid of indication of specific protein marker types in the associated single-channel tiles.

7. The method of claim 5, wherein obtaining the training dataset comprises:
receiving a specific multichannel tile of a multichannel image, and a respective cell type annotation indicating a type of a cell depicted in the specific multichannel tile; and
applying rule-based logic on the cell type annotation, to obtain a plurality of single-channel tile annotations, wherein each single-channel tile annotation (i) pertains to a specific channel of the specific multichannel tile, and (ii) represents protein marker expression in that channel.

8. The method of claim 1, wherein extracting a multichannel tile comprises:
applying a segmentation algorithm on the multichannel image to produce at least one segment representing a depicted biological cell;
calculating a center of mass of said segment; and
defining the multichannel tile as an area of pixels surrounding the calculated center of mass.

9. The method of claim 1, further comprising, for at least one channel of the multichannel image:
calculating a brightness histogram representing distribution of pixel intensities in the channel; and
normalizing intensity values of the channel's pixels based on said distribution.

10. The method of claim 9, wherein normalizing intensity values of the channel's pixels comprises:
identifying a first pixel intensity value, which corresponding to a peak of the brightness histogram, which represents a background region of the channel;
identifying a second pixel intensity value, which directly exceeds the intensity of a predetermined quantile of cells depicted in the multichannel image; and
normalizing intensity values of pixels of the channel according to the range between the first pixel intensity value and the second pixel intensity value.

11. The method of claim 1, further comprising:
obtaining an initial version of a multichannel ML based classification model, configured to classify an example of a multichannel tile according to a type of a biological cell depicted in the example of the multichannel tile;
obtaining an instant multichannel tile, comprising a plurality of single-channel tiles;
inferring the single-channel ML based classifier on one or more of the single-channel tiles of the instant multichannel tile, to predict one or more respective protein marker expression probability values;
based on the one or more protein marker expression probability values, producing a cell-type label, representing a type of the cell depicted in the instant multichannel tile; and
using the cell type label as supervisory information, to retrain the multichannel ML based classification model, so as to predict a type of the biological cell depicted in the instant multichannel tile.

12-23. (canceled)

24. A method of training a deep learning (DL) pipeline for cell typing in multiplex imaging by at least one processor, the method comprising:
receiving one or more multiplex immunofluorescence (mIF) images containing a panel of cell lineage markers;
segmenting the one or more mIF images to identify cell instances in each of the one or more mIF images;
receiving a training set of segmented cells annotated with cell types, wherein said annotation is devoid of indication of specific protein marker types;
cropping the annotated training set images into tiles comprising single cell centers;
feeding the tiles into a DL-based binary classifier; and
training the DL-based classifier to identify cell types.

25. A system for creating a training dataset for a deep learning (DL) multichannel classifier, the system comprising: a non-transitory memory device, wherein modules of instruction code are stored, and at least one processor associated with the memory device, and configured to execute the modules of instruction code, whereupon execution of said modules of instruction code, the at least one processor is configured to:
receive at least one multiplex immunofluorescence (mIF) image;
split the at least one mIF image into a plurality of single channel images;
predict, by a trained single-channel DL classifier, the expression of markers in each of the plurality of single channels, wherein the single-channel ML based classifier is agnostic to protein marker type information;
determine, based on the prediction in each of the plurality of single channel images, and known lineage markers expression data, a cell type in each of the at least one mIF image; and
automatically annotate the at least one mIF image,
wherein the annotated at least one mIF image is added to a training dataset of the DL multichannel classifier.
